(19) United States
(12) Patent Application Publication
(10) Pub. No.: US 2012/0277112 A1
(43) Pub. Date: Nov. 1, 2012

(54) PREDICTING RESPONSE TO ANTI-CANCER THERAPY VIA ARRAY COMPARATIVE GENOMIC HYBRIDIZATION

(75) Inventors: Sabine Charlotte Linn, Amsterdam (NL); Petra Marleen Nederlof, Amsterdam (NL); Marieke Anne Vollebergh, Amsterdam (NL)

(73) Assignee: Stichting Het Nederlands Kanker Instituut

(21) Appl. No.: 13/502,701

(22) PCT Filed: Oct. 19, 2010
(86) PCT No.: PCT/IB2010/002894

§ 371 Date: Jun. 29, 2012

Related U.S. Application Data
(60) Provisional application No. 61/252,928, filed on Oct. 19, 2009.

(51) Int. Cl. C40B 30/04; C40B 40/06

(52) U.S. Cl. 506/9; 506/16

(57) ABSTRACT

Array comparative genomic hybridization classifiers, arrays comprising the classifiers, and related methods of using the same for predicting the therapeutic efficacy of anti-cancer therapy by detecting phenotypic genetic traits using comparative genomic hybridization are disclosed.

### CROSS-REFERENCE TO RELATED APPLICATIONS

This Patent Cooperation Treaty patent application claims priority to U.S. Provisional Patent Application No. 61/252,928 filed Oct. 19, 2009, which is incorporated by reference herein for all purposes in its entirety.

### FIELD

Array comparative genomic hybridization classifiers, arrays comprising the classifiers, and related methods provided by the present disclosure may be used to predict a patient's response to anti-cancer therapy by detecting phenotypic genetic traits using comparative genomic hybridization.

### BACKGROUND

Breast cancer is the most frequently occurring cancer among women in the western world. It is a heterogeneous cancer disease, consisting of several subtypes. Molecular biology has greatly enhanced our understanding of the heterogeneity of breast cancer, but few molecular tumor features are actually used in the clinic to guide the choice of a systemic treatment strategy.

(Neo)adjuvant systemic therapy has become a widely used treatment strategy for patients with early, or locally advanced, breast cancer. Despite its early and late toxicities, this treatment strategy reduces the risk of breast cancer relapse and mortality by approximately half.

In spite of these advantages, a disadvantage to the use of (neo)adjuvant systemic therapy is the lack of predictive tests to individualize the choice of certain combinations of drugs for an individual breast cancer patient to ensure maximal benefit with minimal toxicity. For example, for highly toxic adjuvant treatment regimens, such as high dose alkylating chemotherapy with hematopoietic stem-cell rescue, the survival benefit when compared with standard chemotherapy is approximately 10% for patients with 10 or more positive axillary lymph nodes. It would thus be advantageous to be able to target those 10% of patients who would benefit from high dose alkylating chemotherapy. However, no such predictive test presently exists. Because of the relatively high toxicity and the low level of efficacy in unselected breast cancer patients, alkylating agents are not commonly used in the treatment of breast cancer, with the exception of cyclophosphamide.

Alkylating chemotherapy and platinating agents work by causing interstrand DNA crosslinking, which cause DNA double strand breaks. In normal cells, these double strand breaks are repaired by a process called homologous recombination. If this process is unavailable or impaired, a situation referred to as “homologous recombination deficiency” exists and alternative, error-prone DNA repair mechanisms take over, leading to genomic instability. The breast cancer genes BRCA1 and BRCA2 are involved in normal homologous recombination and tumors of patients carrying germ-line inactivating mutations in one or both of these genes show homologous recombination deficiency. BRCA1 and BRCA2 can also be inactivated in sporadic cancers as well, a phenomenon sometimes referred to as BRCA-likeness. Emerging preclinical evidence shows that breast cancers with a defective DNA repair system, such as a mutation in the BRCA1 or BRCA2 genes, may be extremely sensitive to DNA damaging agents, such as platinum compounds and bifunctional alkylating agents. It therefore appears that patients with breast cancers harboring a defective DNA repair system may specifically benefit from high dose alkylating chemotherapy, an intensive DNA double strand break (DSB)-inducing regimen.

Tumors with homologous recombination deficiency have been shown to be particularly sensitive to DNA crosslinking agents, such as alkylators and platinum drugs or platinating agents. Both classes of drugs are employed in advanced breast cancer. The novel poly(ADP-ribose) polymerase inhibitors (PARP inhibitors) are specifically effective in homologous recombination deficient tumors as well, and have shown impressive activity in clinical studies recently. Unfortunately, no clinical tests exist which can reliably determine homologous recombination deficiency in tumor biopsies.

### SUMMARY

Therefore, methods of predicting the therapeutic efficacy of anti-cancer therapies by identifying patients who would benefit from one or more anti-cancer therapies, including, without limitation, DNA double strand break-inducing regimens such as high dose alkylating chemotherapy, by reliably determining homologous recombination deficiency in tumor biopsies, and by identifying patients with breast cancers harboring a defective DNA repair system, are useful. In various aspects, the DNA double strand break-inducing regimens can be intensive direct DNA double strand break-inducing regimens, intensive indirect DNA double strand break-inducing regimens, moderate direct DNA double strand break-inducing regimens, moderate indirect DNA double strand break-inducing regimens, weak direct DNA double strand break-inducing regimens, weak indirect DNA double strand break-inducing regimens, and/or combinations thereof.

In various aspects, the present disclosure is based on the discovery that certain chromosomal copy number aberrations in tumor cells allow tumors to be classified as BRCA1-associated tumors, or sporadic tumors. The classification of a tumor in this manner allows for the prospective prediction of responsiveness of the patient from which the tumor was removed to anti-cancer therapy.

In a first aspect, methods for using a BRCA1 aCGH classifier to detect genomic copy number variations in a test sample, as compared to a reference sample, in the genomic loci 1p34-21, 3p21, 3q22-27, 5q13-15, 5q21-23, 6p23-22, 10p14, 12q21-23, 13q31-33, and 14q22-24 are disclosed. The methods comprise detecting genomic copy number variations in a test sample in at least one, or in some embodiments a plurality, of the genomic loci selected from 1p34-21, 3p21, 3q22-27, 5q13-15, 5q21-23, 6p23-22, 10p14, 12q21-23, 13q31-33, and 14q22-24, wherein a variation in copy number at any one or more of the genomic loci, as compared to the number of copies per cell of DNA from a reference sample, classifies the cell sample as from a BRCA1-associated tumor, and wherein such classification can be used to predict an individual subject's response to anti-cancer therapy. In some embodiments, the genomic copy number variations are detected at all 10 genomic loci. In some embodiments, the genomic copy number variations are detected at a number of genomic loci selected from greater than 1, greater than 2, greater than 3, greater than 4, greater than 5, greater than 6, greater than 7, greater than 8, and greater than 9. In some embodiments, the genomic copy number variations are detected at a number of genomic loci selected from less than 10, less than 9, less than 8, less than 7, less than 6, less than 5, less than 4, less than 3, and less than 2.

### BRIEF DESCRIPTION OF THE DRAWINGS

Those skilled in the art will understand that the drawings, described herein, are for illustration purposes only. The drawings are not intended to limit the scope of the present disclosure.

FIG. 1 depicts the BRCA1-associated genomic loci used to identify breast cancers with homologous recombination deficiency due to a defect in the BRCA1 pathway.

FIG. 2 depicts exemplary BAC clones that may be used to detect, or to generate probes to detect, copy number aberrations in the genomic loci of FIG. 1.

FIG. 3 depicts the distribution of expression of BRCA1 in sporadic basal-like tumors, normalized against the household genes GAPDH and ACTB.

FIG. 4 depicts the individual expression levels of BRCA1 mRNA in basal-like breast tumors.

FIG. 5 depicts performance of different cut-offs of the BRCA1-probability score using the 191 BAC classifier to identify patients with a progression free survival of more than 24 months. A. Positive predictive values (PPV) and negative predictive values at different cut-offs. Best PPV with cut-off of 0.84. B. Receiver operating curve (ROC). Circle corresponds to cut-off chosen for further analysis.

FIG. 6 depicts Kaplan-Meier curves for progression free survival by BRCA1-like and Non-BRCA1-like classification in the MBC-series. All patients. p-value represents logrank test of equal survival.

FIG. 7 is a flow diagram of patients from the stage-III series. Flow of patients through the study including number of patients in each stage. Reasons for dropout are listed. Abbreviations: ER, estrogen-receptor; aCGH, array comparative genomic hybridization.

### DETAILED DESCRIPTION

### Definitions

“Anti-cancer therapy” means any one, or a plurality, of therapies and/or drugs used to treat cancer, or any combinations thereof, including a) homologous recombination deficiency-targeted drugs and/or treatments; and b) drugs or treatments that directly or indirectly cause double strand DNA breaks. This definition includes, without limitation, high dose platinum-based alkylating chemotherapy, platinum compounds, thiotepa, cyclophosphamide, iphosphamide, nitrosureas, nitrogen mustard derivatives, mitomycins, epipodophyllotoxins, camptothecins, anthracyclines, poly(ADP-ribose) polymerase (PARP) inhibitors, ionizing radiation, ABT-888, olaparib (AZT-2281), gemcitabine, CEP-9722, AG014699, AG014699 with Temozolomide, and BSI-201.

“Array” refers to an arrangement, on a substrate surface, of multiple nucleic acid probes (as defined herein) of predetermined identity. In various embodiments, the sequences of each of the multiple nucleic acid probes are known. In general, an array comprises a plurality of target elements, each target element comprising one or more nucleic acid probes immobilized on one or more solid surfaces, to which sample nucleic acids can be hybridized. In various embodiments, each individual probe is immobilized to a designated, discrete location (i.e., a defined location or assigned position) on the substrate surface. In various embodiments, each nucleic acid probe is immobilized to a discrete location on an array and each has a sequence that is either specific to, or characteristic of, a particular genomic locus. A nucleic acid probe is specific to, or characteristic of, a genomic locus when it contains a nucleic acid sequence that is unique to that genomic locus. Such a probe preferentially hybridizes to a nucleic acid made from that genomic locus, relative to nucleic acids made from other genomic loci.

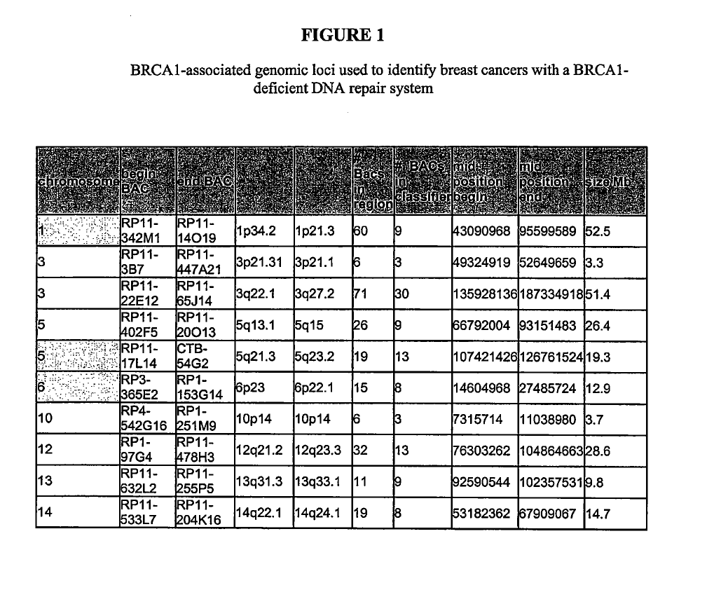

The nucleic acid probes can contain sequence(s) from specific genes or clones. In various embodiments, at least some of the nucleic acid probes contain sequences from any one or more of the specific genomic regions recited in FIG. 1. In various embodiments, at least some of the nucleic acid probes contain sequences of known, reference genes or clones. In various embodiments, the nucleic acid probes in a single array contain both sequences from any one or more of the specific genomic regions recited in FIG. 1 and sequences of known, reference genes or clones.

The probes may be arranged on the substrate in a single density, or in varying densities. The density of each of the probes can be varied to accommodate certain factors such as, for example, the nature of the test sample, the nature of a label used during hybridization, the type of substrate used, and the like. Each probe may comprise a mixture of nucleic acids of varying lengths and, thus, varying sequences. For example, a single probe may contain more than one copy of a cloned nucleic acid, and each copy may be broken into fragments of different lengths. Each length will thus have a different sequence.

The length, sequence and complexity of the nucleic acid probes may be varied. In various embodiments, the length, sequence and complexity are varied to provide optimum hybridization and signal production for a given hybridization procedure, and to provide the required resolution among different genes or genomic locations.

“BRCA1-associated tumor” means a tumor having cells containing a mutation of the BRCA1 locus or a deficiency in the homologous recombination-dependent double strand break DNA repair pathway that alters BRCA1 activity or function, either directly or indirectly.

“CGH” or “Comparative Genomic Hybridization” refers generally to molecular-cytogenetic techniques for the analysis of copy number changes, gains and/or losses, in the DNA content of a given subject's DNA. CGH can be used to identify chromosomal alterations, such as unbalanced chromosomal changes, in any number of cells including, for example, cancer cells. In various embodiments, CGH is utilized to detect one or more chromosomal amplifications and/or deletions of regions between a test sample and a reference sample.

“Chromosomal locus” refers to a specific, defined portion of a chromosome.

“Genome” refers to all nucleic acid sequences, coding and non-coding, present in each cell type of a subject. The term also includes all naturally occurring or induced variation of these sequences that may be present in a mutant or disease variant of any cell type, including, for example, tumor cells. Genomic DNA and genomic nucleic acids are thus nucleic acids isolated from a nucleus of one or more cells, and include nucleic acids derived from, isolated from, amplified from, or cloned from genomic DNA, as well as synthetic versions of all or any part of a genome.

For example, the human genome consists of approximately 3.0×10⁹ base pairs of DNA organized into 46 distinct chromosomes. The genome of a normal human diploid somatic cell consists of 22 pairs of autosomes (chromosomes 1 to 22) and either chromosomes X and Y (male) or a pair of X chromosomes (female) for a total of 46 chromosomes. A genome of a cancer cell may contain variable numbers of each chromosome in addition to deletions, rearrangements and amplification of any sub-chromosomal region or DNA sequence.

“Genomic locus” refers to a specific, defined portion of a genome.

“HBOC tumors” refers to tumors present in a group of patients with a high risk for BRCA1-associated breast cancer (patients from Hereditary Breast and Ovarian Cancer families) but who display a negative screen result for BRCA1 and/or BRCA2 mutation. Such patients have a family history that include at least two breast cancer cases and one ovarian cancer case.

“Hybridization” refers to the binding of two single stranded nucleic acids via complementary base pairing. Extensive guides to the hybridization of nucleic acids can be found in: Tijssen, Laboratory Techniques in Biochemistry and Molecular Biology—Hybridization with Nucleic Acid Probes Part I, Ch. 2, “Overview of principles of hybridization and the strategy of nucleic acid probe assays” (1993), Elsevier, N.Y.; and Sambrook et al., Molecular Cloning: A Laboratory Manual (3rd ed.) Vol. 1-3 (2001), Cold Spring Harbor Laboratory, Cold Spring Harbor Press, N.Y. The phrases “hybridizing specifically to”, “specific hybridization”, and “selectively hybridize to”, refer to the preferential binding, duplexing, or hybridizing of a nucleic acid molecule to a particular probe under stringent conditions. The term “stringent conditions” refers to hybridization conditions under which a probe will hybridize preferentially to its target subsequence, and to a lesser extent, or not at all, to other sequences in a mixed population (e.g., a DNA preparation from a tissue biopsy). “Stringent hybridization” and “stringent hybridization wash conditions” are sequence-dependent and are different under different environmental parameters.

Generally, highly stringent hybridization and wash conditions are selected to be about 5° C. lower than the thermal melting point (Tm) for a specific sequence at a defined ionic strength and pH. The Tm is the temperature at which 50% of the target sequence hybridizes to a perfectly matched probe. Very stringent conditions are selected to be equal to the Tm for a particular probe. Often, a high stringency wash is preceded by a low stringency wash to remove background probe signal. An example of stringent hybridization conditions for hybridization of complementary nucleic acids which have more than 100 complementary residues on an array is 42° C. using standard hybridization solutions, with the hybridization being carried out overnight. An example of highly stringent wash conditions is a 0.15 M NaCl wash at 72° C. for 15 minutes. An example of stringent wash conditions is a wash in 0.2× Standard Saline Citrate (SSC) buffer at 65° C. for 15 minutes. An example of a medium stringency wash for a duplex of, for example, more than 100 nucleotides, is 1×SSC at 45° C. for 15 minutes. An example of a low stringency wash for a duplex of, for example, more than 100 nucleotides, is 4× to 6×SSC at 40° C. for 15 minutes.

“Micro-array” refers to an array that is miniaturized so as to require microscopic examination for visual evaluation. In various embodiments, the arrays used in the methods of the present disclosure are micro-arrays.

“Nucleic acid” refers to a deoxyribonucleotide or ribonucleotide in either single- or double-stranded form and includes all nucleic acids comprising naturally occurring nucleotide bases as well as nucleic acids containing any and/or all analogues of natural nucleotides. This term also includes nucleic acid analogues that are metabolized in a manner similar to naturally occurring nucleotides, but at rates that are improved for the purposes desired. This term also encompasses nucleic-acid-like structures with synthetic backbone analogues including, without limitation, phosphodiester, phosphorothioate, phosphorodithioate, methylphosphonate, phosphoramidate, alkyl phosphotriester, sulfamate, 3′-thioacetal, methylene(methylimino), 3′-N-carbamate, morpholino carbamate, and peptide nucleic acids (PNAs) (see, e.g.: “Oligonucleotides and Analogues, a Practical Approach,” edited by F. Eckstein, IRL Press at Oxford University Press (1991); “Antisense Strategies,” Annals of the New York Academy of Sciences, Volume 600, Eds. Baserga and Denhardt (NYAS 1992); Milligan (1993) J. Med. Chem. 36:1923-1937; and “Antisense Research and Applications” (1993, CRC Press)). PNAs contain non-ionic backbones, such as N-(2-aminoethyl) glycine units. Phosphorothioate linkages are described in: WO 97/03211; WO 96/39154; and Mata (1997) Toxicol. Appl. Pharmacol. 144:189-197. Other synthetic backbones encompassed by this term include methyl-phosphonate linkages or alternating methyl-phosphonate and phosphodiester linkages (Strauss-Soukup (1997) Biochemistry 36: 8692-8698), and benzyl-phosphonate linkages (Samstag (1996) Antisense Nucleic Acid Drug Dev 6: 153-156).

“Probe” or “nucleic acid probe” refer to one or more nucleic acid fragments whose specific hybridization to a sample can be detected. In various embodiments, probes are arranged on a substrate surface in an array. The probe may be unlabelled, or it may contain one or more labels so that its binding to a nucleic acid can be detected. In various embodiments, a probe can be produced from any source of nucleic acids from one or more particular, pre-selected portions of a chromosome including, without limitation, one or more clones, an isolated whole chromosome, an isolated chromosome fragment, or a collection of polymerase chain reaction (PCR) amplification products.

In some embodiments, the probe may be a member of an array of nucleic acids as described in WO 96/17958. Techniques capable of producing high density arrays can also be used for this purpose (see, e.g., Fodor (1991) Science 767-773; Johnston (1998) Curr. Biol. 8: R171-R174; Schummer (1997) Biotechniques 23: 1087-1092; Kern (1997) Biotechniques 23: 120-124; and U.S. Pat. No. 5,143,854).

The sequence of the probes can be varied. In various embodiments, the probe sequence can be varied to produce probes that are substantially identical to the probes disclosed herein, but that retain the ability to hybridize specifically to the same targets or samples as the probe from which they were derived.

“Reference sample” refers to nucleic acids comprising sequences whose quantity or degree of representation, copy number, and/or sequence identity are known. Such nucleic acids serve as a reference to which one or more test samples are compared.

“Sample” refers to a material, or mixture of materials, containing one or more components of interest. Samples include, but are not limited to, material obtained from an organism and may be directly obtained from a source, such as from a biopsy or from a tumor, or indirectly obtained such as after culturing and/or processing.

“Test sample” refers to nucleic acids comprising sequences whose quantity or degree of representation, copy number, and/or sequence identity are unknown. In various embodiments, the present disclosure is directed to the detection of the quantity or degree of representation, copy number, and/or sequence identity of one or more test samples.

Reference is now made in detail to certain embodiments of arrays and methods. The disclosed embodiments are not intended to be limiting of the claims. To the contrary, the claims are intended to cover all alternatives, modifications, and equivalents.

### Arrays, Micro-Arrays and Probes

In various aspects, the present disclosure relates to the determination of copy number changes in the DNA content of a given test sample, as compared to one or more reference samples. In some embodiments, the copy number changes comprise gains or increases in the DNA content of a test sample. In some embodiments, the copy number changes comprise losses or decreases in the DNA content of a test sample. In some embodiments, the copy number changes comprise both gains or increases and losses or decreases in the DNA content of a test sample.

Determination of copy number changes can be determined by hybridizations that are performed on a solid support. For example, probes that selectively hybridize to specific chromosomal regions can be spotted onto a surface. In various aspects, the spots of probes are placed in an ordered pattern, or array, and the pattern is recorded to facilitate correlation of results. Once an array is generated, one or more test samples can be hybridized to the array. In various aspects, arrays comprise a plurality of nucleic acid probes immobilized to discrete spots (i.e., defined locations or assigned positions) on a substrate surface.

Thus, in several aspects, copy number changes of genomic loci are analyzed in an array-based approach. In some embodiments, copy number changes of genomic loci are analyzed using comparative genomic hybridization. In some embodiments, copy number changes of genomic loci are analyzed using array-based comparative genomic hybridization.

Any of a variety of arrays may be used. A number of arrays are commercially available for use from Vysis Corporation (Downers Grove, Ill.), Spectral Genomics Inc. (Houston, Tex.), and Affymetrix Inc. (Santa Clara, Calif.). Arrays can also be custom made for one or more hybridizations.

Methods of making and using arrays are well known in the art (see, e.g., Kern et al., Biotechniques (1997), 23:120-124; Schummer et al., Biotechniques (1997), 23:1087-1092; Solinas-Toldo et al., Genes, Chromosomes & Cancer (1997), 20: 399-407; Johnston, Curr. Biol. (1998), 8: R171-R174; Bowtell, Nature Gen. (1999), Supp. 21:25-32; Watson et al., Biol. Psychiatry (1999), 45: 533-543; Freeman et al., Biotechniques (2000), 29: 1042-1046 and 1048-1055; Lockhart et al., Nature (2000), 405: 827-836; Cuzin, Transfus. Clin. Biol. (2001), 8:291-296; Zarrinkar et al., Genome Res. (2001), 11: 1256-1261; Gabig et al., Acta Biochim. Pol. (2001), 48: 615-622; and Cheung et al., Nature (2001), 40: 953-958; see also, e.g., U.S. Pat. Nos. 5,143,854; 5,434,049; 5,556,752; 5,632,957; 5,700,637; 5,744,305; 5,770,456; 5,800,992; 5,807,522; 5,830,645; 5,856,174; 5,959,098; 5,965,452; 6,013,440; 6,022,963; 6,045,996; 6,048,695; 6,054,270; 6,258,606; 6,261,776; 6,277,489; 6,277,628; 6,365,349; 6,387,626; 6,458,584; 6,503,711; 6,516,276; 6,521,465; 6,558,907; 6,562,565; 6,576,424; 6,587,579; 6,589,726; 6,594,432; 6,599,693; 6,600,031; and 6,613,893).

Substrate surfaces suitable for use in the generation of an array can be made of any rigid, semi-rigid or flexible material that allows for direct or indirect attachment (i.e., immobilization) of nucleic acid probes to the substrate surface. Suitable materials include, without limitation, cellulose (see, e.g., U.S. Pat. No. 5,068,269), cellulose acetate (see, e.g., U.S. Pat. No. 6,048,457), nitrocellulose, glass (see, e.g., U.S. Pat. No. 5,843,767), quartz and/or other crystalline substrates such as gallium arsenide, silicones (see, e.g., U.S. Pat. No. 6,096,817), plastics and plastic copolymers (see, e.g., U.S. Pat. Nos. 4,355,153; 4,652,613; and 6,024,872), membranes and gels (see, e.g., U.S. Pat. No. 5,795,557), and paramagnetic or supramagnetic microparticles (see, e.g., U.S. Pat. No. 5,939,261). When fluorescence is to be detected, arrays comprising cyclo-olefin polymers may be used (see, e.g., U.S. Pat. No. 6,063,338). The presence of reactive functional chemical groups (such as, for example, hydroxyl, carboxyl, and amino groups) present on the surface of the substrate material can be used to directly or indirectly attach nucleic acid probes to the substrate surface.

More than one copy of each nucleic acid probe may be spotted onto an array. For example, each nucleic acid probe may be spotted onto an array once, in duplicate, in triplicate, or more, depending on the desired application. Multiple spots of the same probe allows for assessment of the reproducibility of the results obtained.

Related nucleic acid probes may also be grouped together, in probe elements, on an array. For example, a single probe element may include a plurality of spots of related nucleic acid probes, which are of different lengths but that comprise substantially the same sequence or that are derived from the sequence of a specific genomic locus. Alternatively, a single probe element may include a plurality of spots of related nucleic acid probes that are fragments of different lengths resulting from digestion of more than one copy of a cloned nucleic acid. An array may contain a plurality of probe elements and probe elements may be arranged on an array at different densities.

Array-immobilized nucleic acid probes may be nucleic acids that contain sequences from genes (e.g., from a genomic library) including, for example, sequences that collectively cover a substantially complete genome, or any one or more subsets of a genome. In various embodiments, the sequences of the nucleic acid probes on an array comprise those for which comparative copy number information is desired. In some embodiments, to obtain DNA sequence copy number information across an entire genome, an array comprising nucleic acid probes covering a whole genome or a substantially complete genome is used. In some embodiments, at least one relevant genomic locus has been determined and is used in an array, such that there is no need for genome-wide hybridization. In some embodiments, a plurality of relevant genomic loci have been determined and are used in an array, such that there is no need for genome-wide hybridization. In some embodiments, the array comprises a plurality of specific nucleic acid probes that originate from a discrete set of genes or genomic loci and whose copy number, in association with the type of condition or tumor is to be tested, is known. Additionally, the array may comprise nucleic acid probes that will serve as positive or negative controls. In some embodiments, the array comprises a plurality of nucleic acid sequences derived from karyotypically normal genomes.

The probes may be generated by any number of known techniques (see, e.g., Tijssen, Laboratory Techniques in Biochemistry and Molecular Biology-Hybridization with Nucleic Acid Probes Part I, Ch. 2, “Overview of principles of hybridization and the strategy of nucleic acid probe assays” (1993), Elsevier, N.Y.; Sambrook et al., Molecular Cloning: A Laboratory Manual (3rd ed.) Vol. 1-3 (2001), Cold Spring Harbor Laboratory, Cold Spring Harbor Press, N.Y.; Innis (Ed.) “PCR Strategies” (1995), Academic Press: New York, N.Y.; and Ausubel (Ed.), “Short Protocols in Molecular Biology” 5th Ed. (2002), John Wiley & Sons). Nucleic acid probes may be obtained and manipulated by cloning into various vehicles. They may be screened and re-cloned or amplified from any source of genomic DNA.

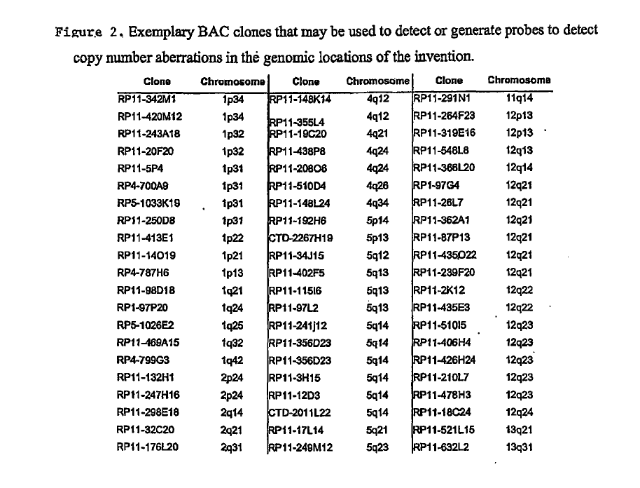

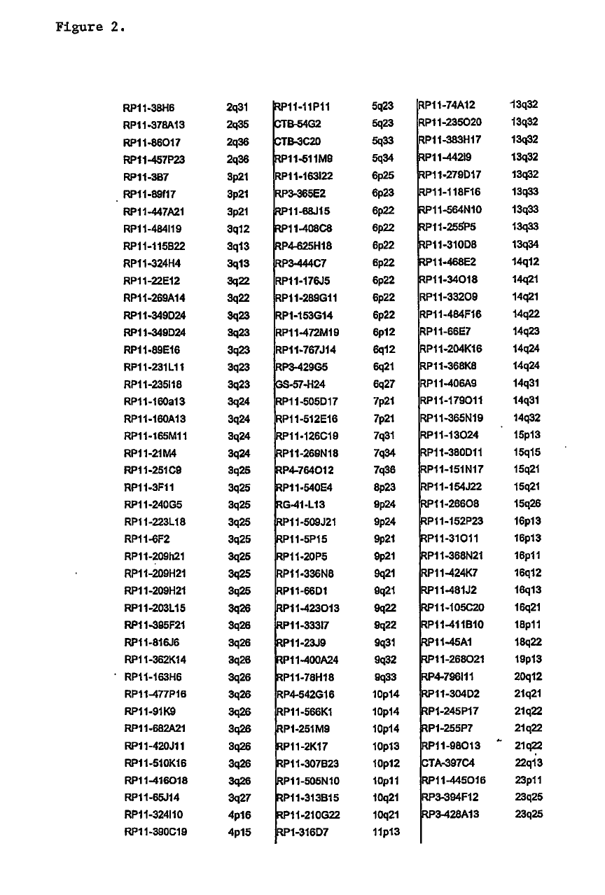

Nucleic acid probes may also be obtained and manipulated by cloning into vehicles including, for example, recombinant viruses, cosmids, or plasmids. Nucleic acid probes may also be synthesized in vitro by chemical techniques (see, e.g., Nucleic Acids Res. (1997), 25: 3440-3444; Blommers et al., Biochemistry (1994), 33: 7886-7896; and Frenkel et al., Free Radic. Biol. Med. (1995), 19: 373-380). Probes may vary in size from synthetic oligonucleotide probes and/or PCR-type amplification primers of a few base pairs in length to artificial chromosomes of more than 1 megabases in length. In various embodiments, probes comprise at least 10, at least 12, at least 15, at least 18, at least 20, at least 22, at least 30, at least 50 or at least 100 contiguous nucleotides of a sequence present in a BAC clone set forth in FIG. 2. In various embodiments, probes also comprise at least 10, at least 12, at least 15, at least 18, at least 20, at least 22, at least 30, at least 50 or at least 100 contiguous nucleotides of a sequence present in one or more reference samples. In some embodiments, probes comprise a sequence that is unique in a genome. In some embodiments, probes comprise a sequence that is unique in the human genome.

Probes may be obtained from any number of commercial sources. For instance, several P1 clones are available from the DuPont P1 library (see, e.g., Shepard et al., Proc. Natl. Acad. Sci. USA (1994), 92: 2629), and available commercially from Incyte Corporation (Wilmington, Del.). Various libraries spanning entire chromosomes are available commercially from Clontech Laboratories, Inc. (Mountain View, Calif.), or from the Los Alamos National Laboratory (Los Alamos, Calif.). In various aspects, the present disclosure relates to the use of the human 3600 BAC/PAC genomic clone set, covering the full human genome at 1 Mb spacing, obtained from the Wellcome Trust Sanger Institute (Hinxton, Cambridge, UK).

In some embodiments, the nucleic acid probes are derived from mammalian artificial chromosomes (MACs) and/or human artificial chromosomes (HACs), which can contain inserts from about 5 to 400 kilobases (kb) (see, e.g., Roush, Science (1997), 276: 38-39; Rosenfeld, Nat. Genet. (1997), 15: 333-335; Ascenzioni et al., Cancer Lett. (1997), 118: 135-142; Kuroiwa et al., Nat. Biotechnol. (2000), 18: 1086-1090; Meija et al., Am. J. Hum. Genet. (2001), 69: 315-326; and Auriche et al., EMBO Rep. (2001), 2: 102-107).

In some embodiments, the nucleic acid probes are derived from satellite artificial chromosomes or satellite DNA-based artificial chromosomes (SATACs). SATACs can be produced by inducing de novo chromosome formation in cells of varying mammalian species (see, e.g., Warburton et al., Nature (1997), 386: 553-555; Csonka et al., J. Cell. Sci. (2000), 113: 3207-3216; and Hadlaczky, Curr. Opin. Mol. Ther. (2001), 3: 125-132).

In some embodiments, the nucleic acid probes are derived from yeast artificial chromosomes (YACs), 0.2-1 megabses in size. YACs have been used for many years for the stable propagation of genomic fragments of up to one million base pairs in size (see, e.g., Feingold et al., Proc. Natl. Acad. Sci. USA (1990), 87:8637-8641; Adam et al., Plant J. (1997), 11: 1349-1358; Tucker et al., Gene (1997), 199: 25-30; and Zeschnigk et al., Nucleic Acids Res. (1999), 27: E30).

In some embodiments, the nucleic acid probes are derived from bacterial artificial chromosomes (BACs) up to 300 kb in size. BACs are based on the E. coli F factor plasmid system and are typically easy to manipulate and purify in microgram quantities (see, e.g., Asakawa et al., Gene (1997), 191: 69-79; and Cao et al., Genome Res. (1999), 9: 763-774).

In some embodiments, the nucleic acid probes are derived from P1 artificial chromosomes (PACs), about 70-100 kb in size. PACs are bacteriophage P1-derived vectors (see, e.g., Ioannou et al., Nature Genet. (1994), 6: 84-89; Boren et al., Genome Res. (1996), 6: 1123-1130; Nothwang et al., Genomics (1997), 41: 370-378; Reid et al., Genomics (1997), 43: 366-375; and Woon et al., Genomics (1998), 50: 306-316).

In some embodiments, the array comprises a series of separate wells or chambers on the substrate surface, into which probes may be immobilized as described herein. The probes can be immobilized in the separate wells or chambers and hybridization can take place within the wells or chambers. In various embodiments, the arrays can be selected from chips, microfluidic chips, microtiter plates, Petri dishes, and centrifuge tubes. Robotic equipment has been developed for these types of arrays that permit automated delivery of reagents into the separate wells or chambers which allow the amount of the reagents used per hybridization to be sharply reduced. Examples of chip and microfluidic chip techniques can be found, for example, in U.S. Pat. No. 5,800,690; Orchid, “Running on Parallel Lines” New Scientist (1997); McCormick et al., Anal. Chem. (1997), 69:2626-30; and Turgeon, “The Lab of the Future on CD-ROM?” Medical Laboratory Management Report. December 1997, p. 1.

In some embodiments, arrays may be generated by isolating DNA from one or more artificial chromosomes, such as for example BACs, according to standard procedures. For example, in some embodiments, DNA can be isolated from one or more BACs using a Qiawell plasmid kit (Qiagen, Chatsworth, Calif.). Total DNA can be amplified from the insert sites of the BACs via degenerate oligonucleotide primed PCR using a set of degenerate primers with a C6-NH₂ modification at their 5′ end for covalent attachment to a substrate surface. The substrates may be any type suitable for such use including, for example, CODELINK™ glass slides (Corning, Cambridge, UK). Covalent attachment to the substrate can occur via the manufacturer's suggested protocols, or via other detailed protocols (such as those described in Pinkel et al., Nature Genetics (1998), 20:207-211) with some modifications (such as those described in Alers et al. 1999). The DNA obtained after PCR amplification can then be spotted onto the substrate surface for covalent attachment thereto. The DNA may be spotted as a single site, in duplicate or in triplicate on the substrate surface.

### BRCA1 Arrays

An array comparative genomic hybridization (aCGH) profile that distinguishes BRCA1-mutated breast cancers from sporadic breast cancers has been identified and is disclosed in PCT Publication No. WO 2009/048328. In various aspects, the present disclosure relates to the use of a BRCA1 array comprising the BRCA1 aCGH profile disclosed herein to identify breast cancers with a homologous recombination deficiency due to a defect in BRCA1 or in the HR pathway which results in a BRCA1-like phenotype, and to thus identify patients, from whom the cancers have been excised, who will be highly sensitive to certain anti-cancer therapy. Therefore, in various aspects, the present disclosure relates to the use of a BRCA1 array comprising the BRCA1 aCGH profile disclosed herein to prospectively optimize the therapeutic efficacy of anti-cancer therapy in an individual subject by detecting phenotypic genetic traits associated with deficiencies in the BRCA1 gene or in the HR pathway which results in a BRCA1-like phenotype.

In various embodiments, a BRCA1 array comprising a BRCA1 aCGH profile for identifying individual subjects who will experience a therapeutic benefit from anti-cancer therapy is provided. In various aspects, arrays provided by the present disclosure, which in some embodiments are BRCA1 arrays, can comprise at least one, or in some embodiments a plurality, of the BAC clones of FIG. 2 immobilized on a substrate surface. In various aspects, arrays provided by the present disclosure, which in some embodiments are BRCA1 arrays, can comprise at least one, or in some embodiments a plurality, of the BAC clones of FIG. 2 immobilized to discrete spots on a substrate surface. In some embodiments, an array comprises all 191 of the BAC clones set forth in FIG. 2 immobilized on a substrate surface. In some embodiments, an array comprises all 191 of the BAC clones set forth in FIG. 2, immobilized to a plurality of discrete spots on a substrate surface. In some embodiments, arrays provided by the present disclosure comprise a number of the BAC clones set forth in FIG. 2 selected from greater than 1, greater than 10, greater than 20, greater than 25, greater than 50, greater than 75, greater than 100, greater than 125, greater than 150, greater than 175 and greater than 190. In some embodiments, the BAC clones comprising the arrays of the preceding sentence are immobilized to a plurality of discrete spots on a substrate surface. In some embodiments, arrays provided by the present disclosure comprise a number of the BAC clones set forth in FIG. 2 selected from less than 191, less than 175, less than 150, less than 125, less than 100, less than 75, less than 50, less than 25, less than 20, and less than 10. In some embodiments, the BAC clones comprising the arrays of the preceding sentence are immobilized to a plurality of discrete spots on a substrate surface. In various aspects, arrays provided by the present disclosure can also comprise at least one, or in some embodiments a plurality, of nucleic acid probes from a reference sample immobilized on a substrate surface. In various aspects, arrays provided by the present disclosure can also comprise at least one, or in some embodiments a plurality, of nucleic acid probes from a reference sample immobilized to discrete spots on a substrate surface. In some embodiments, a BRCA1 array is used to detect BRCA1-associated genomic copy number variations in a test sample, as compared to a reference sample, at one, or a plurality, of the genomic loci selected from 1p34-21, 3p21, 3q22-27, 5q13-15, 5q21-23, 6p23-22, 10p14, 12q21-23, 13q31-33, and 14q22-24. In some embodiments, a BRCA1 array is used to detect an increase in genomic copy numbers in a test sample, as compared to a reference sample, in any one, or a plurality, of the genomic loci selected from 1p34-21, 3q22-27, 6p23-22, 10p14 and 13q31-33. In some embodiments, a BRCA1 array is used to detect a decrease in genomic copy numbers in a test sample, as compared to a reference sample, in any one, or a plurality, of the genomic loci selected from 3p21, 5q13-15, 5q21-23, 12q21-23 and 14q22-24. In each of the aforementioned embodiments, detection of BRCA1-associated genomic copy number variations classifies the test sample as from a BRCA1-associated tumor and classifies the subject from whom the test sample was excised as an individual who will experience a therapeutic benefit from anti-cancer therapy.

The genomic loci may be detected individually, or in any combination of two or more loci. In some embodiments, a BRCA1 array is used that is capable of detecting BRCA1-associated genomic copy number variations in all 10 of the above-listed chromosomal loci. In some embodiments, a BRCA1 array is used that is capable of detecting BRCA1-associated genomic copy number variations in a number of genomic loci selected from greater than 1, greater than 2, greater than 3, greater than 4, greater than 5, greater than 6, greater than 7, greater than 8, and greater than 9. In some embodiments, a BRCA1 array is used that is capable of detecting BRCA1-associated genomic copy number variations in a number of genomic loci selected from less than 10, less than 9, less than 8, less than 7, less than 6, less than 5, less than 4, less than 3, and less than 2. In some embodiments, a BRCA1 array is used that is capable of detecting BRCA1-associated genomic copy number variations in all 10 of the BRCA1-associated genomic loci set forth in FIG. 1. In some embodiments, a BRCA1 array is used that is capable of detecting BRCA1-associated genomic copy number variations in at least one, or a plurality, of the genomic loci selected from 3p21, 3q22-27, 5q13-15, 5q21-23, 6p23-22, 10p14, 12q21-23, 13q31-33, and 14q22-24. In some embodiments, a BRCA1 array is used that is capable of detecting BRCA1-associated genomic copy number variations in at least one, or a plurality, of the genomic loci selected from 3p21, 3q22-27, 5q13-15, 6p23-22, 10p14, 12q21-23, 13q31-33, and 14q22-24. In some embodiments, a BRCA1 array is used that is capable of detecting BRCA1-associated genomic copy number variations in at least one, or a plurality, of the genomic loci selected from 3p21, 3q22-27, 5q13-15, 10p14, 12q21-23, 13q31-33, and 14q22-24. In some embodiments, a BRCA1 array is used that is capable of detecting BRCA1-associated genomic copy number variations in at least one, or a plurality, of the genomic loci selected from 3p21, 3q22-27, 5q13-15, 10p14, 12q21-23 and 13q31-33. In some embodiments, a BRCA1 array is used that is capable of detecting BRCA1-associated genomic copy number variations in at least one, or a plurality, of the genomic loci selected from 3q22-27, 5q13-15, 10p14, 12q21-23 and 13q31-33. In some embodiments, a BRCA1 array is used that is capable of detecting BRCA1-associated genomic copy number variations in at least one, or a plurality, of the genomic loci selected from 3q22-27, 5q13-15, 12q21-23 and 13q31-33. In some embodiments, a BRCA1 array is used that is capable of detecting BRCA1-associated genomic copy number variations in at least one, or a plurality, of the genomic loci selected from 3q22-27, 5q13-15 and 13q31-33. In each of the aforementioned embodiments, detection of BRCA1-associated genomic copy number variations classifies the test sample as from a BRCA1-associated tumor and classifies the subject from whom the test sample was excised as an individual who will experience a therapeutic benefit from anti-cancer therapy.

The BRCA1 arrays comprise at least one probe. In various embodiments, the BRCA1 arrays comprise a plurality of probes. In some embodiments, the BRCA1 arrays comprise a plurality of probes, wherein the probes comprise nucleic acid sequences derived from BAC clones. The BRCA1-associated genomic loci set forth in FIG. 1 are bounded by the BAC probes set forth in FIG. 2. In some embodiments, arrays capable of detecting BRCA1-associated genomic copy number variations comprise at least one, or a plurality, of probes derived from the BAC clones of FIG. 2. The BAC clones set forth in FIG. 2 are not intended to be limiting in any way, and other probes within the BRCA1-associated genomic loci of FIG. 1 can also be used in the BRCA1 arrays. In some embodiments, arrays capable of detecting BRCA1-associated genomic copy number variations comprise all 191 of the BAC clones of FIG. 2. In some embodiments, arrays capable of detecting BRCA1-associated genomic copy number variations comprise a number of BAC clones of FIG. 2 selected from greater than 1, greater than 10, greater than 20, greater than 25, greater than 50, greater than 75, greater than 100, greater than 125, greater than 150, and greater than 175. In some embodiments, arrays capable of detecting BRCA1-associated genomic copy number variations comprise a number of BAC clones of FIG. 2 selected from less than 191, less than 175, less than 150, less than 125, less than 100, less than 75, less than 50, less than 25, less than 20, and less than 10.

In some embodiments, a BRCA1 array capable of detecting BRCA1-associated genomic copy number variations comprises at least one, or a plurality, of probes that independently hybridize to at least one, or a plurality, of the genomic loci selected from 3p21, 3q22-27, 5q13-15, 5q21-23, 6p23-22, 10p14, 12q21-23, 13q31-33, and 14q22-24. In some embodiments, a BRCA1 array capable of detecting BRCA1-associated genomic copy number variations comprises at least one, or a plurality, of probes that independently hybridize to at least one, or a plurality, of the genomic loci selected from 3p21, 3q22-27, 5q13-15, 6p23-22, 10p14, 12q21-23, 13q31-33, and 14q22-24. In some embodiments, a BRCA1 array capable of detecting BRCA1-associated genomic copy number variations comprises at least one, or a plurality, of probes that independently hybridize to at least one, or a plurality, of the genomic loci selected from 3p21, 3q22-27, 5q13-15, 10p14, 12q21-23, 13q31-33 and 14q22-24. In some embodiments, a BRCA1 array capable of detecting BRCA1-associated genomic copy number variations comprises at least one, or a plurality, of probes that independently hybridize to at least one, or a plurality, of the genomic loci selected from 3p21, 3q22-27, 5q13-15, 10p14, 12q21-23 and 13q31-33. In some embodiments, a BRCA1 array capable of detecting BRCA1-associated genomic copy number variations comprises at least one, or a plurality, of probes that independently hybridize to at least one, or a plurality, of the genomic loci selected from 3q22-27, 5q13-15, 10p14, 12q21-23 and 13q31-33. In some embodiments, a BRCA1 array capable of detecting BRCA1-associated genomic copy number variations comprises at least one, or a plurality, of probes that independently hybridize to at least one, or a plurality, of the genomic loci selected from 3q22-27, 5q13-15, 12q21-23 and 13q31-33. In some embodiments, a BRCA1 array capable of detecting BRCA1-associated genomic copy number variations comprises at least one, or a plurality, of probes that independently hybridize to at least one, or a plurality, of the genomic loci selected from 3q22-27, 5q13-15 and 13q31-33. In these embodiments, the probes are as defined above and/or may be obtained in methods as described above.

In some embodiments, BRCA1 arrays capable of detecting BRCA1-associated genomic copy number variations comprise at least one, or a plurality, of probes, wherein the probes comprise at least one, or a plurality, of the distinct BAC clones of FIG. 2. In some embodiments, BRCA1 arrays capable of detecting BRCA1-associated genomic copy number variations comprise at least one, or a plurality, of probes, wherein the probes comprise at least one, or a plurality, of the BAC clones of FIG. 2, and wherein the probes specifically hybridize to at least 1, at least 2, at least 3, at least 4, at least 5, at least 6, at least 7, at least 8, at least 9, or at least 10 of the genomic loci set forth in FIG. 1. In some embodiments, BRCA1 arrays capable of detecting BRCA1-associated genomic copy number variations comprise a plurality of probes, wherein the nucleic acid sequences of the probes are unique to the genomic loci set forth in FIG. 1. In some embodiments, BRCA1 arrays capable of detecting BRCA1-associated genomic copy number variations comprise a plurality of probes, wherein the probes comprise a plurality of BAC clones specific to all of the genomic loci set forth in FIG. 1. In some embodiments, BRCA1 arrays capable of detecting BRCA1-associated genomic copy number variations comprise at least one, or a plurality, of probes, wherein the probes comprise at least 1, at least 2, at least 3, at least 4, at least 5, at least 6, at least 7, at least 8, at least 9, at least 10, at least 15, at least 20, at least 25, at least 50, at least 75, at least 100, at least 1250, at least 150, or at least 175 of the distinct BAC clones of FIG. 2.

In various embodiments, BRCA1 arrays capable of detecting BRCA1-associated genomic copy number variations that comprise at least one, or a plurality, of probes, and/or that comprise at least one, or a plurality, of distinct BAC clones, allow for the individual analysis of at least one, or a plurality, of distinct genomic loci. Therefore, in some embodiments, the probes, and/or the distinct BAC clones, capable of detecting BRCA1-associated genomic copy number variations are arranged on the BRCA1 arrays in a positionally-addressable manner.

In various embodiments, BRCA1 arrays capable of detecting BRCA1-associated genomic copy number variations comprise at least one, or a plurality, of distinct BAC clones, wherein the distinct BAC clones represent at least 1, at least 2, at least 3, at least 4, at least 5, at least 6, at least 7, at least 8, or at least 9 of the genomic loci set forth in FIG. 1. In various embodiments, BRCA1 arrays capable of detecting BRCA1-associated genomic copy number variations comprise at least one, or a plurality, of distinct BAC clones, wherein the distinct BAC clones represent all 10 of the genomic loci set forth in FIG. 1.

### Array Comparative Genomic Hybridization

In various aspects, the present disclosure relates to the analysis of tumor cell samples by array-based comparative genomic hybridization. Array comparative genomic hybridization (aCGH) is a technique that is used to detect genomic copy number variations at a higher level of resolution than chromosome-based comparative genomic hybridization. In aCGH, nucleic acids from a test sample and nucleic acids from a reference sample are labelled differentially. The test sample and the reference sample are then hybridized to an array comprising a plurality of probes. The ratio of the signal intensity of the test sample to that of the reference sample is then calculated, to measure the copy number changes for a particular location in the genome. The difference in the signal ratio determines whether the total copy numbers of the nucleic acids in the test sample are increased or decreased as compared to the reference sample. The test sample and the reference sample may be hybridized to the array separately or they may be mixed together and hybridized simultaneously. Exemplary methods of performing aCGH can be found, for example, in U.S. Pat. Nos. 5,635,351; 5,665,549; 5,721,098; 5,830,645; 5,856,097; 5,965,362; 5,976,790; 6,159,685; 6,197,501; and 6,335,167; European Patent Nos. EP 1 134 293 and EP 1 026 260; van Beers et al., Brit. J. Cancer (2006), 20; Joosse et al., BMC Cancer (2007), 7:43; Pinkel et al., Nat. Genet. (1998), 20: 207-211; Pollack et al., Nat. Genet. (1999), 23: 41-46; and Cooper, Breast Cancer Res. (2001), 3: 158-175.

Samples that are labelled differentially are labelled such that one of the two samples is labelled with a first detectable agent and the other of the two samples is labelled with a second detectable agent, wherein the first detectable agent and the second detectable agent produce distinguishable signals. Detectable agents that produce distinguishable signals can include, for example, matched pairs of fluorescent dyes.

In some embodiments, the methods of the present disclosure comprise analyzing at least one test sample of tumor DNA from a subject by array-based comparative genomic hybridization to obtain information relating to the copy number aberrations present in the sample(s), if any; and based on the information obtained, classifying the tumor as a BRCA1-associated tumor or a sporadic tumor; and, based on the classification, optimizing the therapeutic efficacy of anti-cancer therapy for the subject by predicting the subject's prospective response to anti-cancer therapy.

Information relating to the copy number aberrations present in a sample can include, for example, a gain of genetic material at one or more genomic loci, a loss of genetic material at one or more genomic loci, chromosomal abnormalities at one or more genomic loci, and genome copy number changes at one or more genomic loci. This information is obtained by analyzing the difference in signal intensity between the test sample and a reference sample at one or more genomic loci. The analysis can be performed using any of a variety of methods, means and variations thereof for carrying out array-based comparative genomic hybridization.

In various embodiments, the reference sample is a nucleic acid sample that is representative of a normal, non-diseased state, for example a non-tumor/non-cancer cell, and contains a normal amount of copy numbers of the complement of the genomic loci being tested. The reference sample may be derived from a genomic nucleic acid sample from a normal and/or healthy individual or from a pool of such individuals. In various embodiments, the reference sample does not comprise any tumor or cancerous nucleic acids. In some embodiments, the reference sample is derived from a pool of female subjects. In some embodiments, the reference sample comprises pooled genomic DNA isolated from tissue samples (e.g. lymphocytes) from a plurality (e.g. at least 4-10) of healthy female subjects. In some embodiments, the reference sample comprises an artificially-generated population of nucleic acids designed to approximate the copy number level from each tested genomic region, or fragments of each tested genomic region. In some embodiments, the reference sample is derived from normal, non-cancerous cell lines or from cell line samples.

Test samples may be obtained from a biological source comprising tumor cells, and reference samples may be obtained from a biological source comprising normal reference cells, by any suitable method of nucleic acid isolation and/or extraction. In various aspects, the test sample and the reference sample are DNA. Methods of DNA extraction are well known in the art. A classical DNA isolation protocol is based on extraction using organic solvents, such as a mixture of phenol and chloroform, followed by precipitation with ethanol (see, e.g., Sambrook et al., supra). Other methods include salting out DNA extraction, trimethylammonium bromide salt extraction, and guanidinium thiocyanate extraction. Additionally, there are numerous DNA extraction kits that are commercially available from, for example, BD Biosciences Clontech (Palo Alto, Calif.), Epicentre Technologies (Madison, Wis.), Gentra Systems, Inc. (Minneapolis, Minn.), MicroProbe Corp. (Bothell, Wash.), Organon Teknika (Durham, N.C.), and Qiagen Inc. (Valencia, Calif.).

The test samples and the reference samples may be differentially labelled with any detectable agents or moieties. In various embodiments, the detectable agents or moieties are selected such that they generate signals that can be readily measured and such that the intensity of the signals is proportional to the amount of labelled nucleic acids present in the sample. In various embodiments, the detectable agents or moieties are selected such that they generate localized signals, thereby allowing resolution of the signals from each spot on an array.

Methods for labeling nucleic acids are well-known in the art. For exemplary reviews of labeling protocols, label detection techniques and recent developments in the field, see: Kricka, Ann. Clin. Biochem. (2002), 39: 114-129; van Gijlswijk et al., Expert Rev. Mol. Diagn. (2001), 1: 81-91; and Joos et al., J. Biotechnol. (1994), 35: 135-153. Standard nucleic acid labeling methods include: incorporation of radioactive agents, direct attachment of fluorescent dyes or of enzymes, chemical modification of nucleic acids to make them detectable immunochemically or by other affinity reactions, and enzyme-mediated labeling methods including, without limitation, random priming, nick translation, PCR and tailing with terminal transferase. Other suitable labeling methods include psoralen-biotin, photoreactive azido derivatives, and DNA alkylating agents. In various embodiments, test sample and reference sample nucleic acids are labelled by Universal Linkage System, which is based on the reaction of monoreactive cisplatin derivatives with the N7 position of guanine moieties in DNA (see, e.g., Heetebrij et al., Cytogenet. Cell. Genet. (1999), 87: 47-52).

Any of a wide variety of detectable agents or moieties can be used to label test and/or reference samples. Suitable detectable agents or moieties include, but are not limited to: various ligands; radionuclides such as, for example, ³²P, ³⁵S, ³H, ¹⁴C, ¹²⁵I, ¹³¹I, and others; fluorescent dyes; chemiluminescent agents such as, for example, acridinium esters, stabilized dioxetanes, and others; microparticles such as, for example, quantum dots, nanocrystals, phosphors and others; enzymes such as, for example, those used in an ELISA, horseradish peroxidase, beta-galactosidase, luciferase, alkaline phosphatase and others; colorimetric labels such as, for example, dyes, colloidal gold and others; magnetic labels such as, for example, Dynabeads™; and biotin, dioxigenin or other haptens and proteins for which antisera or monoclonal antibodies are available.

In some embodiments, the test samples and the reference samples are labelled with fluorescent dyes. Suitable fluorescent dyes include, without limitation, Cy-3, Cy-5, Texas red, FITC, Spectrum Red, Spectrum Green, phycoerythrin, rhodamine, and fluorescein, as well as equivalents, analogues and/or derivatives thereof. In some embodiments, the fluorescent dyes selected display a high molar absorption coefficient, high fluorescence quantum yield, and photostability. In some embodiments, the fluorescent dyes exhibit absorption and emission wavelengths in the visible spectrum (i.e., between 400 nm and 750 nm) rather than in the ultraviolet range of the spectrum (i.e., lower than 400 nm). In some embodiments, the fluorescent dyes are Cy-3 (3-N,N′-diethyltetramethylindo-dicarbocyanine) and Cy-5 (5-N,N′-diethyltetramethylindo-dicarbocyanine). Cy-3 and Cy-5 form a matched pair of fluorescent labels that are compatible with most fluorescence detection systems for array-based instruments. In some embodiments, the fluorescent dyes are Spectrum Red and Spectrum Green.

A key component of aCGH is the hybridization of a test sample and a reference sample to an array. Exemplary hybridization and wash protocols are described, for example, in Sambrook et al. (2001), supra; Tijssen (1993), supra; and Anderson (Ed.), “Nucleic Acid Hybridization” (1999), Springer Verlag: New York, N.Y. In some embodiments, the hybridization protocols used for aCGH are those of Pinkel et al., Nature Genetics (1998), 20:207-211. In some embodiments, the hybridization protocols used for aCGH are those of Kallioniemi, Proc. Natl. Acad. Sci. USA (1992), 89:5321-5325.

Methods of optimizing hybridization conditions are well known in the art (see, e.g., Tijssen, (1993), supra). To create competitive hybridization conditions, the array may be contacted simultaneously with differentially labelled nucleic acid fragments of the test sample and the reference sample. This may be done by, for example, mixing the labelled test sample and the labelled reference sample together to form a hybridization mixture, and contacting the array with the mixture.

The specificity of hybridization may be enhanced by inhibiting repetitive sequences. In some embodiments, repetitive sequences (e.g., Alu sequences, L1 sequences, satellite sequences, MRE sequences, simple homo-nucleotide tracts, and/or simple oligonucleotide tracts) present in the nucleic acids of the test sample, reference sample and/or probes are either removed, or their hybridization capacity is disabled. Removing repetitive sequences or disabling their hybridization capacity can be accomplished using any of a variety of well-known methods. These methods include, but are not limited to, removing repetitive sequences by hybridization to specific nucleic acid sequences immobilized to a solid support (see, e.g., Brison et al., Mol. Cell. Biol. (1982), 2: 578-587); suppressing the production of repetitive sequences by PCR amplification using adequately designed PCR primers; inhibiting the hybridization capacity of highly repeated sequences by self-reassociation (see, e.g., Britten et al., Methods of Enzymology (1974), 29: 363-418); or removing repetitive sequences using hydroxyapatite which is commercially available from a number of sources including, for example, Bio-Rad Laboratories, Richmond, Va. In some embodiments, the hybridization capacity of highly repeated sequences in a test sample and/or in a reference sample is competitively inhibited by including, in the hybridization mixture, unlabelled blocking nucleic acids. The unlabelled blocking nucleic acids are therefore mixed with the hybridization mixture, and thus with a test sample and a reference sample, before the mixture is contacted with an array. The unlabelled blocking nucleic acids act as a competitor for the highly repeated sequences and bind to them before the hybridization mixture is contacted with an array. Therefore, the unlabelled blocking nucleic acids prevent labelled repetitive sequences from binding to any highly repetitive sequences of the nucleic acid probes, thus decreasing the amount of background signal present in a given hybridization. In some embodiments, the unlabelled blocking nucleic acids are Human Cot-1 DNA. Human Cot-1 DNA is commercially available from a number of sources including, for example, Gibco/BRL Life Technologies (Gaithersburg, Md.).

Once hybridization is complete, the ratio of the signal intensity of the test sample as compared to the signal intensity of the reference sample is calculated. This calculation quantifies the amount of copy number aberrations present in the genomic DNA of the test sample, if any. In some embodiments, this calculation is carried out quantitatively or semi-quantitatively. In several aspects, it is not necessary to determine the exact copy number aberrations present in the genomic loci tested, as detection of an aberration, i.e. a gain or loss of genetic material, from the copy number in normal, non-cancerous genomic DNA is indicative of the presence of a disease state and is thus sufficient. Therefore, in several embodiments the quantification of the amount of copy number aberrations present in the genomic DNA of a test sample comprises an estimation of the copy number aberrations, as a semi-quantitative or relative measure usually suffices to predict the presence of a disease state and thus prospectively direct the determination of therapy for a subject.

Quantitative techniques may be used to determine the copy number aberrations per cell present in a test sample. Several quantitative and semi-quantitative techniques to determine copy number aberrations exist including, for example, semi-quantitative PCR analysis or quantitative real-time PCR. The Polymerase Chain Reaction (PCR) per se is not a quantitative technique, however PCR-based methods have been developed that are quantitative or semi-quantitative in that they give a reasonable estimate of original copy numbers, within certain limits. Examples of such PCR techniques include, for example, quantitative PCR and quantitative real-time PCR (also known as RT-PCR, RQ-PCR, QRT-PCR or RTQ-PCR). In addition, many techniques exist that give estimates of relative copy numbers, as calculated relative to a reference. Such techniques include many array-based techniques. Absolute copy number estimates may be obtained by in situ hybridization techniques such as, for example, fluorescence in situ hybridization or chromogenic in situ hybridization.

Fluorescence in situ hybridization permits the analysis of copy numbers of individual genomic locations and can be used to study copy numbers of individual genetic loci or particular regions on a chromosome (see, e.g., Pinkel et al., Proc. Natl. Acad. Sci. U.S.A. (1988), 85, 9138-42). Comparative genomic hybridization can also be used to probe for copy number changes of chromosomal regions (see, e.g., Kallioniemi et al., Science (1992), 258: 818-21; and Houldsworth et al., Am. J. Pathol. (1994), 145: 1253-60).

Copy numbers of genomic locations may also be determined using quantitative PCR techniques such as real-time PCR (see, e.g., Suzuki et al., Cancer Res. (2000), 60:5405-9). For example, quantitative microsatellite analysis can be performed for rapid measurement of relative DNA sequence copy numbers. In quantitative microsatellite analysis, the copy numbers of a test sample relative to a reference sample is assessed using quantitative, real-time PCR amplification of loci carrying simple sequence repeats. Simple sequence repeats are used because of the large numbers that have been precisely mapped in numerous organisms. Exemplary protocols for quantitative PCR are provided in Innis et al., PCR Protocols, A Guide to Methods and Applications (1990), Academic Press, Inc. N.Y. Semi-quantitative techniques that may be used to determine specific DNA copy numbers include, for example, multiplex ligation-dependent probe amplification (see, e.g., Schouten et al. Nucleic Acids Res. (2002), 30(12):e57; and Seliner et al., Human Mutation (2004), 23(5):413-419) and multiplex amplification and probe hybridization (see, e.g., Seliner et al. (2004), supra).

### BRCA1 Array Comparative Genomic Hybridization

In various aspects, the present disclosure relates to the use of a BRCA1 aCGH classifier capable of identifying BRCA1-associated tumors in predicting an individual subject's response to anti-cancer therapy. In various aspects, a BRCA1 aCGH classifier capable of identifying BRCA1-associated tumors is set forth on a BRCA1 array as described herein.

Using the methods described above, in various aspects, a BRCA1 aCGH classifier, which in some embodiments is present in an array as described herein, is capable of detecting genomic copy number variations in a test sample, as compared to a reference sample, in at least one, or a plurality, of the genomic loci selected from 1p34-21, 3p21, 3q22-27, 5q13-15, 5q21-23, 6p23-22, 10p14, 12q21-23, 13q31-33, and 14q22-24. Using the methods described above, in various aspects, a BRCA1 aCGH classifier, which in some embodiments is present in an array as described herein, is capable of detecting genomic copy number variations in a test sample, as compared to a reference sample, in at least one, or a plurality, of the genomic loci selected from 1p34.2-21.3, 3p21.31-21.1, 3q22.1-27.2, 5q13.1-15, 5q21.3-23.2, 6p23-22.1, 10p14, 12q21.2-23.3, 13q31.3-33.1 and 14q22.1-24.1. Using the methods described above, in various aspects, a BRCA1 aCGH classifier, which in some embodiments is present in an array as described herein, is capable of detecting genomic copy number variations in a test sample, as compared to a reference sample, in at least one, or a plurality, of the genomic loci set forth in FIG. 1. In some embodiments, a BRCA1 aCGH classifier, which in some embodiments is present in an array as described herein, is capable of detecting genomic copy number variations at a number of the above-listed genomic loci selected from greater than 1, greater than 2, greater than 3, greater than 4, greater than 5, greater than 6, greater than 7, greater than 8 and greater than 9. In some embodiments, a BRCA1 aCGH classifier, which in some embodiments is present in an array as described herein, is capable of detecting genomic copy number variations at a number of the above-listed genomic loci selected from less than 10, less than 9, less than 8, less than 7, less than 6, less than 5, less than 4, less than 3, and less than 2.

Using the methods described above, in various aspects, a BRCA1 aCGH classifier, which in some embodiments is present in an array as described herein, is capable of detecting genomic copy number variations in a test sample, using at least one, or a plurality, of probes that independently hybridize to at least one genomic locus set forth in FIG. 1. Using the methods described above, in various aspects, a BRCA1 aCGH classifier, which in some embodiments is present in an array as described herein, is capable of detecting genomic copy number variations in a test sample, as compared to a reference sample, using at least one, or a plurality, of the distinct BAC clones set forth in FIG. 2. In some embodiments, a BRCA1 aCGH classifier, which in some embodiments is present in an array as described herein, is capable of detecting genomic copy number variations in a test sample comprises a number of the BAC clones set forth in FIG. 2 selected from greater than 1, greater than 10, greater than 20, greater than 25, greater than 50, greater than 75, greater than 100, greater than 125, greater than 150, greater than 175 and greater than 190. In some embodiments, a BRCA1 aCGH classifier, which in some embodiments is present in an array as described herein, is capable of detecting genomic copy number variations in a test sample comprises a number of the BAC clones set forth in FIG. 2 selected from less than 191, less than 175, less than 150, less than 125, less than 100, less than 75, less than 50, less than 25, less than 20, and less than 10.

### Therapeutic Uses

In various aspects, the BRCA1 classifiers, which in some embodiments are present in one or more arrays as described herein, can be used to predict an individual subject's response to anti-cancer therapy.

Using the methods described above, in various aspects, the BRCA1 classifiers are capable of determining whether an individual metastatic breast cancer patient, in continuous complete remission after high dose alkylating chemotherapy, has a BRCA1-associated tumor. Using the methods described above, in various aspects, the BRCA1 classifiers are capable of determining whether a metastatic breast cancer patient with a BRCA1-associated tumor has a significantly higher complete remission rate. The BRCA1 classifiers are therefore capable of predicting response to anti-cancer therapy in an individual patient. Using the methods described above, in various aspects, the BRCA1 classifiers are capable of predicting improved outcome after platinum-based high dose alkylating chemotherapy by identifying breast cancer patients specifically benefiting from HD-chemotherapy within ER-low and HER2-negative stage-III breast cancer.

The BRCA1 classifiers can be used as pre-selection tools, to prospectively detect subjects with a high risk of carrying a BRCA1-mutation and/or a BRCA1-associated tumor. Additionally, the BRCA1 classifiers can be used as predictive tests to identify breast cancer patients likely to benefit from anti-cancer therapy.

The BRCA1 classifiers can also be used to detect a BRCA1 profile in ER+ luminal sporadic tumors. It is therefore believed that the BRCA1 classifiers can also be used as predictive tests to identify breast cancer patients having ER+ luminal sporadic tumors who are likely to benefit from anti-cancer therapy.

For the first time, in this disclosure, clinical evidence has been provided to show that patients with so-called “triple negative” sporadic tumors who also display a BRCA1 profile, as determined by the BRCA1 classifiers, are more sensitive and respond better to high dose alkylating chemotherapy containing carboplatin, thiotepa, and cyclophosphamide (see, for example, the following Examples). Therefore, the use of the BRCA1 classifiers can be used to prospectively predict how an individual subject will respond to anti-cancer therapy. Until the present disclosure, no such test had been available.

As shown in the Examples, the BRCA1 classifiers have been applied, via aCGH, to search for “BRCA1-like” patterns in metastatic tumors. Those patterns, where found, have been related to the treatment results of anti-cancer therapy. What has been discovered, and what is disclosed in the present disclosure, is that all of the long-term survivors of stage IV breast cancer studied had tumors that displayed the BRCA1-like patterns discoverable by the BRCA1 classifiers of the present disclosure. It is also shown that triple-negative tumors that displayed the BRCA1-like patterns benefited markedly from high-dose alkylating therapy in the adjuvant setting, while the triple-negative tumors displaying sporadic-like patterns did not.

The examples provide evidence of a relation between the BRCA1-like pattern, detectable by the BRCA1 classifiers, and better treatment response to anti-cancer therapy. The examples also provide evidence that BRCA1 inactivation in triple negative tumors, information relating to which can be obtained by the use of the BRCA1 classifiers, may identify patients that respond better to alkylating agents.

The BRCA1 classifiers can be used in a clinical setting to detect the presence or absence of homologous recombination deficiency in ER-low, HER2-negative, stage-III breast cancer patients. As shown in the examples, a comparison of the rates of cancer recurrence in patients treated based on the results and/or information obtained from use of the BRCA1-classifiers disclosed herein (i.e. patients with a BRCA1-like tumor: HD-chemotherapy, others: conventional chemotherapy) with the rates of cancer recurrence in patients treated with conventional chemotherapy (substitute of current clinical practice), resulted in a multivariate HR of 0.47 (95% CI 0.23-0.91). Therefore, recurrence rates for ER-low, HER2-negative stage-III breast cancers can be cut in half by utilizing the BRCA1 classifiers to tailor chemotherapy treatment.

In further aspects, the present disclosure relates to kits for use in the diagnostic applications described above. The kits can comprise any or all of the reagents to perform the methods described herein. The kits can comprise one or more of the BRCA1 classifiers, which in some embodiments are present in one or more arrays, as described herein. In the diagnostic applications such kits may include any or all of the following: assay reagents, buffers, nucleic acids such as hybridization probes and/or primers that specifically bind to at least one of the genomic locations described herein, as well as arrays comprising such nucleic acids. In addition, the kits may include instructional materials containing directions (i.e., protocols) for the practice of the methods of this disclosure. While the instructional materials typically comprise written or printed materials they are not limited to such. Any medium capable of storing such instructions and communicating them to an end user is contemplated by this disclosure. Such media include, but are not limited to electronic storage media (e.g., magnetic discs, tapes, cartridges, chips), optical media (e.g., CD ROM), and the like. Such media may include addresses to internet sites that provide such instructional materials.

### EXAMPLES

The following examples describe in detail the therapeutic efficacy of chemotherapy by detecting phenotypic genetic traits using the BRCA1 classifiers disclosed herein in comparative genomic hybridization. It will be apparent to those skilled in the art that many modifications, both to materials and methods, may be practiced without departing from the scope of the disclosure.

### Example 1

### Homologous Recombination Deficiency in Breast Cancer and Association with Response to Neo-Adjuvant Chemotherapy

Tumors with homologous recombination deficiency (HRD), such as BRCA1 associated breast cancers, are not able to reliably repair DNA double strand breaks (DSBs), and are highly sensitive to alkylating agents and PARP inhibitors. In this Example, markers that may indicate the presence of HRD in patients with HER2-negative breast cancer, scheduled to receive neoadjuvant chemotherapy, were studied. Forty-three triple negative (TN) and 91 estrogen receptor positive (ER+) pre-treatment biopsies from sporadic breast cancer patients were examined. Inactivation of BRCA1 was frequent in TN tumors: 54% of these tumors showed a ‘BRCA1-like’ pattern at array Comparative Genomic Hybridization (aCGH), and BRCA1 promoter methylation and reduced BRCA1 mRNA expression were observed in, respectively, 25% and 43% of the TN tumors. In conclusion, abnormalities associated with BRCA1 inactivation are present in about half of the TN breast cancers and may identify tumors that are sensitive to chemotherapy that causes DNA DSBs.

Patients and Methods

Patients

Pre-treatment biopsies of primary breast tumors from 134 women with HER2 negative breast cancer were collected. All patients had received neoadjuvant treatment at the Netherlands Cancer Institute between 2000 and 2007 as part of two ongoing clinical trials, or were treated off protocol according to the standard arm of one of these studies. Both studies had been approved by the ethical committee and written informed consent was obtained. For eligibility, breast carcinoma with either a primary tumor size of at least 3 cm was required, or the presence of fine needle aspiration (FNA)-proven axillary lymph node metastases. Biopsies were taken using a 14 G core needle under ultrasound guidance. After collection, specimens were snap-frozen in liquid nitrogen and stored at −70° C. Each patient had two or three biopsies taken to assure that enough tumor material was available for both diagnosis and further study.

Depending on the particular study, a treatment regimen was assigned to each patient, which consisted of one of the following: 1.) Six courses of dose-dense Doxorubicin/Cyclophosphamide (ddAC); or 2.) Six courses of Capecitabine/Docetaxel (CD); or 3.) Three courses of ddAC followed by three courses CD (or vice versa) if the therapy response was considered unfavorable by MRI evaluation after three courses. For the response analysis only those patients who started with ddAC (group 1 and group 3) were considered.

Response Evaluation

The response of the primary tumor to chemotherapy was evaluated by contrast-enhanced MRI (Loo, C. E., Teertstra, H. J., Rodenhuis, S., et al Dynamic contrast-enhanced MRI for prediction of breast cancer response to neoadjuvant chemotherapy: initial results, AJR Am J Roentgenol, 191: 1331-1338, 2008) after 3 courses of chemotherapy, and after surgery by pathologic evaluation of the resection specimen. The primary end point of both studies was a pCR, defined as the complete absence of residual invasive tumor cells seen at microscopy. If only non-invasive tumor (carcinoma in situ) was detected, this was considered a pCR as well. When a small number of scattered tumor cells were seen, the samples were classified as ‘near pCR’ (npCR). Because the aim of this study was to determine if HRD was correlated with a higher sensitivity to chemotherapy, tumors with a npCR were included in the group of complete remission for analytical purposes. Patients with larger amounts of residual tumor left were classified as non-responders (NR).

Array-CGH

Tumor DNA and reference DNA were co-hybridized using two different CyDyes to a microarray containing 3.5 k BAC/PAC derived DNA segments covering the whole genome with an average spacing of 1 MB and processed as described before (Joosse, S. A., van Beers, E. H. and Nederlof, P. M. Automated array-CGH optimized for archival formalin-fixed, paraffin-embedded tumor material, BMC Cancer, 7: 43, 2007). Classification of subtypes was performed using the aCGH BRCA1 classifier developed by Joosse et al. (Joosse, S. A., van Beers, E. H., Tielen, I. H., et al Prediction of BRCA1-association in hereditary non-BRCA1/2 breast carcinomas with array-CGH, Breast Cancer Res Treat, 2008; and Joosse, S. A., Brandwijk, K. I. M., Devilee, P., et al Prediction of BRCA2-association in hereditary breast carcinomas with array-CGH, Breast Cancer Res Treat. 2010 Jul. 8. PubMed PMID: 20614180). When the BRCA1 score was 0.50 or higher the tumor was qualified as BRCA1-like (Joosse, S. A., Brandwijk, K. I. M., Devilee, P., et al Prediction of BRCA2-association in hereditary breast carcinomas with array-CGH, Breast Cancer Res Treat. 2010 Jul. 8. PubMed PMID: 20614180). Under this cut-off a tumor was called sporadic-like. For response analysis a cut-off of 0.8 was also applied (Joosse, S. A., van Beers, E. H., Tielen, I. H., et al Prediction of BRCA1-association in hereditary non-BRCA1/2 breast carcinomas with array-CGH, Breast Cancer Res Treat, 2008).

RT PCR

mRNA isolation and extraction were performed using RNA Bee, according to the manufacturers protocol (Isotex, Friendswood, Tex.). A 5 μm section halfway through the biopsy was stained for Hematoxylin and Eosin and analyzed by a pathologist for tumor cell percentage. Only samples that contained at least 60% tumor cells were included in further analysis. RT-qPCR was performed using TaqMan Pre-designed gene expression Assay for BRCA1 (#Hs01556193). The standard curve method was used. GAPDH and B-actin were measured for normalization purposes and the average of both gene expression values was used. The cut-off between BRCA1 low and normal gene expression was 0.28. This cut-off was empirically determined (see results section).

MLPA

Hypermethylation of the BRCA1 promoter was determined using a custom Methylation specific MLPA set, according to the manufacturers' protocol (MRC-Holland; ME005-custom). When the two BRCA1 markers showed both methylation, it was termed BRCA1 promoter methylation. Amplification of EMSY (C11orf30) was determined using a custom MLPA set, containing seven different EMSY probes and nine reference probes (MRC Holland; X025). This EMSY MLPA set was first validated by an EMSY FISH assay (Dako). From the comparison of the EMSY FISH assay and the MLPA, it was concluded that an average of the seven probes above 1.5 corresponded to EMSY amplification, as detected by at least 6 copies of the probe at the FISH assay. DNA fragments were analyzed on a 3730 DNA Analyzer (AB, USA). For normalization and analysis the Coffalizer program was used (MRC-Holland).

Statistical Tests

The Fisher's exact test was used to assess association between the dichotomized HRD characteristics and treatment response. The Mann-Whitney U test was used to analyze means of variables and relate it to treatment response. All data analyses were performed using SPSS version 15.

Results

Overview of Samples

In the series of patients described in this Example, the frequency of features associated with HRD in pre-treatment biopsies was studied, and possible relationships with response to chemotherapy known to cause a modest amount of DNA DSBs were explored. HER2+ tumors were not investigated in this study, because they were treated with regimens based on trastuzumab and taxanes, agents that do not cause DNA DSBs. Array CGH, promoter methylation and RT-PCR expression levels of BRCA1, and EMSY amplification were determined, since these tests can be performed reliably on small pretreatment biopsies. aCGH was used to assess ‘BRCA-ness’. If the pattern of genomic alterations resembled that of BRCA1 tumors the sample was called BRCA1-like. If no pattern was recognized the tumor was called sporadic-like. A total of 134 tumors were studied, of which 91 were ER+ and 43 were Triple Negative tumors. See Table 1 for an overview of the different patients.

TABLE 1
Patient and tumor characteristics

| | | TN | | ER+ | |
|---|---|---|---|---|---|
| Number of patients | | 43 | | 91 | |
| Median age (sd) | | 45 (11.18) | | 50.5 (9.14) | |
| Progesterone receptor | Positive | 0 | 0% | 58 | 64% |
| | Negative | 100 | 100% | 33 | 36% |
| T-stage | T1 | 2 | 5% | 12 | 13% |
| | T2 | 29 | 67% | 51 | 56% |
| | T3 | 11 | 26% | 25 | 28% |
| | T4 | 1 | 2% | 3 | 3% |
| N-stage | Node negative | 28 | 65% | 22 | 24% |
| | Node positive | 15 | 35% | 69 | 76% |
| Initial chemotherapy | AC | 38 | 88% | 81 | 89% |
| | DC | 2 | 5% | 7 | 8% |
| | other | 3 | 7% | 3 | 3% |
| Response | pCR | 15 | 34% | 6 | 7% |
| | npCR | 7 | 16% | 12 | 13% |
| | NR | 19 | 44% | 67 | 74% |
| | unknown | 2 | 5% | 6 | 7% |

AC = doxorubicin, cyclophosphamide;
DC = docetaxel, capecitabine;
(n)pCR = (near) pathological complete remission;
NR = non response

aCGH was performed in 37 TN and 75 ER+ tumors. The BRCA1-like profile was predominantly seen in TN tumors (54% in TN vs 3% in ER+ tumors, p<0.001), (Table 2). Other features of BRCA1 inactivation were assessed by determination of BRCA1 promoter methylation and the level of BRCA1 mRNA expression. These BRCA1 characteristics were again predominantly observed in TN tumors, but were less frequent than a BRCA1 aCGH pattern, 25% of TN tumors showed BRCA1 promoter methylation and 43% of TN tumors showed a low BRCA1 gene expression. This initial analysis shows that BRCA1 characteristics are more frequently observed in TN tumors, while an EMSY amplification is specific for ER+ tumors. This is in concordance with the fact that tumors in BRCA1 carriers are almost always TN (Chappuis, P. O., Nethercot, V. and Foulkes, W. D. Clinico-pathological characteristics of B, Semin Surg Oncol, 18: 287-295, 2000).

TABLE 2
Summary of HRD characteristics

| | TN (n = 43) | ER+ (n = 91) | p-value |
|---|---|---|---|
| aCGH BRCA1-like | | | |
| B1-like | 20 (54%) | 2 (3%) | |
| Sp-like | 17 (46%) | 73 (97%) | <0.001 |
| BRCA1 methylation | | | |
| Meth | 9 (25%) | 1 (2%) | |
| Unmeth | 27 (75%) | 42 (98%) | 0.004 |
| BRCA1expression | | | |
| Low | 12 (43%) | 2 (4%) | |
| Normal | 16 (57%) | 55 (96%) | <0.001 |
| EMSY Amplification | | | |
| Amplification | 0 (0%) | 9 (15%) | |
| No amplification | 23 (100%) | 51 (85%) | 0.057 |

TN Tumors and BRCA1-Like Pattern

In Table 3, an overview of HRD characteristics of the individual tumors is presented. A high percentage of BRCA1-likeness is observed in the TN tumors (54%). As a cut-off for BRCA1-positivity, 50% concordance with the idealized BRCA1-like signature was used (Joosse, S. A., van Beers, E. H., Tielen, I. H., et al Prediction of BRCA1-association in hereditary non-BRCA1/2 breast carcinomas with array-CGH, Breast Cancer Res Treat, 2008), which is the standard in the Netherlands Cancer Institute when the test is employed in the setting of hereditary breast cancer. Consequently, tumors are classified as either BRCA1-like or sporadic-like. To determine a cut off value for low versus normal BRCA1 gene expression, the values in methylated and non-methylated samples were considered. It was assumed that methylated samples would have low mRNA expression, whereas unmethylated samples could vary in their expression. When 0.28 was taken as the cut off value for low versus normal expression, all methylated samples had a low BRCA1 expression, whereas most unmethylated samples have a normal BRCA1 expression level. The median mRNA gene expression of methylated samples was 0.156 while unmethylated samples show a value of 0.398, this difference was significant (p=0.001). Additionally, the relation between the BRCA1-like pattern and mRNA expression was examined, as one would expect that low expression would be associated with a BRCA1-like pattern. Indeed, most BRCA1-like samples have a low expression of the BRCA1 gene, whereas sporadic-like samples have more frequently a normal mRNA expression. Samples with a BRCA1-like profile have a median mRNA expression of 0.226, while sporadic-like samples have a median mRNA expression value of 0.406, which shows a clear tendency. From the nine tumors with BRCA1 promoter methylation, six had a BRCA1 like pattern and three a sporadic like pattern. These data show that the three BRCA1 related characteristics are only partly correlated to each other.

TABLE 3
Overview of HRD characteristics in TN tumors*

| Sample | BRCA1 | BRCA1 | BRCA1 | EMSY |
|---|---|---|---|---|
| Number | like | methylation | (RT-PCR) | amplification |
| 2079 | + | + | low | − |
| 2066 | + | + | low | − |
| 2108 | + | + | low | − |
| 2034 | + | + | low | |
| 2136 | + | − | | |
| 2009 | + | − | low | |
| 2052 | + | − | low | |
| 2131 | + | − | low | − |
| 2124 | + | − | normal | − |
| 2101 | + | − | normal | − |
| 2142 | + | − | normal | − |
| 2078 | + | − | normal | − |
| 99 | + | − | normal | |
| 127 | + | − | normal | − |
| 141 | + | − | normal | |
| 155 | + | − | normal | − |
| 188 | + | − | normal | − |
| 144 | + | | | |
| 105 | + | + | | − |
| 161 | + | + | low | |
| 2031 | − | + | low | |
| 101 | − | + | low | − |
| 168 | − | + | low | − |
| 2123 | − | − | | − |
| 132 | − | − | normal | − |
| 159 | − | − | low | − |
| 97 | − | | | |
| 2129 | − | − | | |
| 2091 | − | | | − |
| 2127 | − | | | |

*Only samples with at least one characteristic are shown.

Next, the association between BRCA1 inactivation and clinical and pathological variables and response to chemotherapy with weakly DSBs causing agents was studied (Table 4). It was determined to confine this analysis to a BRCA1 like profile, because this characteristic was available for most subjects and was correlated to BRCA1 methylation and low gene expression. There was no difference in T-stage or N-stage between BRCA1-like tumors and sporadic-like tumors (Table 4). A slightly higher response rate in the BRCA1-like tumors compared with the sporadic-like samples was observed (58% vs. 46%, p=0.720 for the 0.5 cut-off and 70% vs. 42%, p=0.231 for the 0.8 cut-off). These differences are not statistically significant, which may be explained by the ACdd regimen used, which is known to be only a weak DNA DSB inducing regimen, albeit more effective than for instance conventional chemotherapy consisting of 5-fluorouracil, epirubicin and cyclophosphamide (FEC) administered once every three weeks.

TABLE 4
Association between BRCAl-like pattern and clinical
pathological variables in TN tumors

| | BRCA1-like pattern | | |
|---|---|---|---|
| | BRCA1-like | Sporadic-like | p-value |
| T-stage | | | |
| 1 | 2/20 (10%) | 0 | |
| 2 | 15/20 (75%) | 12/17 (71%) | |
| 3 | 3/20 (15%) | 5/17 (29%) | |
| N-stage | | | |
| Pos | 12/20 (60%) | 11/17 (65%) | 1 |
| Response on NC* | | | |
| pCR + npCR | 11/19 (58%) | 6/13 (46%) | 0.720 |
| (cut-off 0.5) | | | |
| pCR + npCR | 7/10 (70%) | 5/12 (42%) | 0.231 |
| (cut-off 0.8)** | | | |

*Response was measured only on samples from patients whose initial chemotherapy was doxorubicin/cyclophosphamide (A/C)
**0.8 is the old initial cut-off value; nowadays 0.5 is used in the clinical setting

Discussion

Classical chemotherapeutic agents that cause DNA double-strand breaks (DSBs) are thought to be particularly effective in tumors with HRD (Kennedy, R. D., Quinn, J. E., Mullan, P. B., Johnston, P. G. and Harkin, D. P. The role of BRCA1 in the cellular response to chemotherapy, J Natl Cancer Inst, 96: 1659-1668, 2004; Fedier, A., Steiner, R. A., Schwarz, V. A., Lenherr, L., Haller, U. and Fink, D. The effect of loss of Brca1 on the sensitivity to anticancer agents in p53-deficient cells, Int J Oncol, 22: 1169-1173, 2003; Helleday, T., Petermann, E., Lundin, C., Hodgson, B. and Sharma, R. A. DNA repair pathways as targets for cancer therapy, Nat Rev Cancer, 8: 193-204, 2008; Moynahan, M. E., Cui, T. Y. and Jasin, M. Homology-directed dna repair, mitomycin-c resistance, and chromosome stability is restored with correction of a Brca1 mutation, Cancer Res, 61: 4842-4850, 2001; and Powell, S. N. and Kachnic, L. A. Therapeutic exploitation of tumor cell defects in homologous recombination, Anticancer Agents Med Chem, 8: 448-460, 2008) and the novel class of PARP inhibiting drugs has been shown to have marked antitumor activity with very little toxicity (Bryant, H. E., Schultz, N., Thomas, H. D., et al Specific killing of BRCA2-deficient tumors with inhibitors of poly(ADP-ribose) polymerase, Nature, 434: 913-917, 2005; and Farmer, H., McCabe, N., Lord, C. J., et al Targeting the DNA repair defect in BRCA mutant cells as a therapeutic strategy, Nature, 434: 917-921, 2005). Unfortunately, a demonstration of HRD in clinical tumor samples is problematic. One reported assay measures DSB repair pathways, but requires short-term cultures of primary breast cancer cells (Keimling, M., Kaur, J., Bagadi, S. A., Kreienberg, R., Wiesmuller, L. and Ralhan, R. A sensitive test for the detection of specific DSB repair defects in primary cells from breast cancer specimens, Int J Cancer, 123: 730-736, 2008). Immunohistochemical methods have been proposed as well, aiming to detect CHK1 and RAD51 localization in the cytoplasm and/or the nucleus (Honrado, E., Osorio, A., Palacios, J., et al Immunohistochemical expression of DNA repair proteins in familial breast cancer differentiate BRCA2-associated tumors, J Clin Oncol, 23: 7503-7511, 2005), but reliable immunohistochemical staining results can be difficult to obtain. Others have used methylation assays for BRCA1 (Esteller, M., Silva, J. M., Dominguez, G., et al Promoter hypermethylation and BRCA1 inactivation in sporadic breast and ovarian tumors, J Natl Cancer Inst, 92: 564-569, 2000; and Catteau, A., Harris, W. H., Xu, C. F. and Solomon, E. Methylation of the BRCA1 promoter region in sporadic breast and ovarian cancer: correlation with disease characteristics, Oncogene, 18: 1957-1965, 1999), FancC and FancD and have studied EMSY amplification (Rodriguez, C., Hughes-Davies, L., Valles, H., et al Amplification of the BRCA2 pathway gene EMSY in sporadic breast cancer is related to negative outcome, Clin Cancer Res, 10: 5785-5791, 2004), e.g. by an in situ hybridization assay (Turner, N., Tutt, A. and Ashworth, A. Hallmarks of ‘BRCAness’ in sporadic cancers, Nat Rev Cancer, 4: 814-819, 2004). The sensitivity and specificity of these approaches is unknown and a possible association of these features with neoadjuvant treatment response has not been reported.

In prior studies performed at the Netherlands Cancer Institute, high-dose alkylating chemotherapy in the treatment of patients with breast cancer, with either a high risk of relapse (Rodenhuis, S., Bontenbal, M., Beex, L. V., et al High-dose chemotherapy with hematopoietic stem-cell rescue for high-risk breast cancer, N Engl J Med, 349: 7-16, 2003) or with distant metastases (Schrama, J. G., Baars, J. W., Holtkamp, M. J., Schomagel, J. H., Beijnen, J. H. and Rodenhuis, S. Phase II study of a multi-course high-dose chemotherapy regimen incorporating cyclophosphamide, thiotepa, and carboplatin in stage IV breast cancer, Bone Marrow Transplant, 28: 173-180, 2001) has been employed. In both studies, a modest survival advantage for patients who had received this intensive treatment was noted, a result which has also been documented in meta-analyses of the randomized studies (Berry, D. A., Ueno, N. T., Johnson, M. M., et al High-dose chemotherapy with autologous stem-cell support versus standard-dose chemotherapy: meta-analysis of individual patient data from 6 randomized metastatic breast cancer trials, Proc. San Antonio Breast Cancer Symp, Abstract 6113:2008). These observations are consistent with the existence of a putative subgroup of breast cancers that is highly responsive to alkylating drugs, as has been speculated previously based on clinical observations (Rodenhuis, S. The status of high-dose chemotherapy in breast cancer, Oncologist, 5: 369-375, 2000; and Rodenhuis, S. High-dose chemotherapy in breast cancer—interpretation of the randomized trials, Anticancer Drugs, 12: 85-88, 2001). This subgroup could overlap or even be identical with the subgroup of tumors that show HRD. To study this hypothesis, Vollebergh et al. have recently applied the aCGH test to search for the ‘BRCA1 like’ pattern (Joosse, S. A., van Beers, E. H., Tielen, I. H., et al Prediction of BRCA1-association in hereditary non-BRCA1/2 breast carcinomas with array-CGH, Breast Cancer Res Treat, 2008; Wessels, L. F., van Welsem, T., Hart, A. A., Van't Veer, L. J., Reinders, M. J. and Nederlof, P. M. Molecular classification of breast carcinomas by comparative genomic hybridization: a specific somatic genetic profile for BRCA1 tumors, Cancer Res, 62: 7110-7117, 2002; and van Beers, E. H., van Welsem, T., Wessels, L. F., et al Comparative genomic hybridization profiles in human BRCA1 and BRCA2 breast tumors highlight differential sets of genomic aberrations, Cancer Res, 65: 822-827, 2005) in metastatic tumors and related it to the treatment results of intensive alkylating chemotherapy (Vollebergh, M. A., Nederlof, P. M., Wessels, L. F., et al A clinical test for BRCAness: using aCGH to predict response to platinum-based chemotherapy in breast cancer patients, Ann Oncol, 2010, in press It turned out that all long-term survivors of stage IV breast cancer had tumors with the BRCA1-like signature. It was shown in a second retrospective study, that triple-negative tumors with the BRCA1-signature benefited markedly from high-dose therapy in the adjuvant setting, while the triple-negative tumors with a sporadic like profile did not (Vollebergh, M. A., Nederlof, P. M., Wessels, L. F., et al A clinical test for BRCAness: using aCGH to predict response to platinum-based chemotherapy in breast cancer patients, Ann Oncol, 2010, in press).

In the series of patients described in this Example, the frequency of certain features associated with HRD in untreated breast cancers was studied and possible relationships with neoadjuvant treatment response were explored. HER2+ tumors were not investigated in this study, because they are treated with different agents, such as trastuzumab and taxanes, which do not cause DSBs. Half of the triple negative tumors showed BRCA1 inactivation, as shown by a BRCA1 like aCGH pattern, BRCA1 promoter methylation and BRCA1 mRNA down regulation.

Features of BRCA1 Inactivation

A BRCA1 like aCGH profile, BRCA1 promoter methylation and a low BRCA1 gene expression were present, often in combination, in the triple negative tumors. A BRCA1-like profile was the most frequently detected characteristic. BRCA1 promoter methylation and a low gene expression were both seen in tumors with a BRCA1-like profile and in tumors with a sporadic-like profile. However, not all tumors with a BRCA1-like profile had one of the other two characteristics. Other studies examining BRCA1 expression in sporadic tumors have generated conflicting results. Reduced BRCA1 expression as measured by MC was detected in two different studies (Abd El-Rehim, D. M., Ball, G., Pinder, S. E., et al High-throughput protein expression analysis using tissue microarray technology of a large well-characterised series identifies biologically distinct classes of breast cancer confirming recent cDNA expression analyses, Int J Cancer, 116: 340-350, 2005; and Ribeiro-Silva, A., Ramalho, L. N., Garcia, S. B., Brandao, D. F., Chahud, F. and Zucoloto, S. p63 correlates with both BRCA1 and cytokeratin 5 in invasive breast carcinomas: further evidence for the pathogenesis of the basal phenotype of breast cancer, Histopathology, 47: 458-466, 2005). However, other studies reported that BRCA1 expression was maintained in basal-like tumors, and that there was no promoter methylation (Richardson, A. L., Wang, Z. C., De Nicolo, A., et al X chromosomal abnormalities in basal-like human breast cancer, Cancer Cell, 9: 121-132, 2006; and Matros, E., Wang, Z. C., Lodeiro, G., Miron, A., Iglehart, J. D. and Richardson, A. L. BRCA1 promoter methylation in sporadic breast tumors: relationship to gene expression profiles, Breast Cancer Res Treat, 91: 179-186, 2005). Interestingly, one of these studies found instead promoter methylation in ER+ tumors, whereas in the present study promoter methylation was specific for TN tumors. A further study in basal-like tumors found downregulation of BRCA1 mRNA, but promoter methylation was only detected in a specific subset of metaplastic tumors (Turner, N. C., Reis-Filho, J. S., Russell, A. M., et al BRCA1 dysfunction in sporadic basal-like breast cancer, Oncogene, 26: 2126-2132, 2007). The study of Vollebergh et al. (Vollebergh, M. A., Nederlof, P. M., Wessels, L. F., et al A clinical test for BRCAness: using aCGH to predict response to platinum-based chemotherapy in breast cancer patients, Ann Oncol, 2010, in press) points to a relation between the BRCA1 like pattern and a better treatment response to intensive alkylating chemotherapy.

Conclusion

Tests that show BRCA1 inactivation in TN tumors may be used identify patients that respond better to DNA DSB-inducing regimens, than patients with tumors without positive tests for BRCA1 inactivation.

### Example 2

### The Genomic Signature of BRCA1 Deficiency in Hereditary and Sporadic Basal-Like Tumors

Investigation of 41 basal-like tumors for BRCA1 expression by real-time PCR, BRCA1 promoter methylation status, and genomic profile by array-CGH was performed to further understand the involvement of BRCA1 deficiency in sporadic basal-like tumors. The results were compared to 34 known BRCA1-mutated tumors.

The basal-like tumors could be subdivided based on BRCA1 gene expression levels in high and low BRCA1 expressing tumors. The BRCA1 promoter methylation status correlated excellent with the BRCA1 expression levels. As expected, the aCGH profiles of basal-like sporadic tumors with a low BRCA1 expression resemble the aCGH profiles of BRCA1-mutated tumors more than the basal-like tumors highly expressing BRCA1. This indicates that basal-like tumors can be subdivided in to tumors with and without BRCA1 deficiency.

Methods

Tumor Specimens

The study set forth in this Example was performed on two breast cancer groups of which all individual cases were negative for ER, PR, and HER2 expression by NC and scored as histological grade III. The first group consisted of 41 sporadic basal-like breast tumors of IDC type, mean age at diagnosis of 48 years (age range: 26-82), gene expression and histopathological data were available from an earlier study from the Netherlands Cancer Institute (Kreike B, van Kouwenhove M, Horlings H, Weigelt B, Peterse H, Bartelink H and van de Vijver M J. (2007). Breast Cancer Res, 9, R65.). The second group included 34 breast carcinomas from patients with a confirmed pathogenic BRCA1 germ line mutation, mean age at diagnosis of 38 years (age range: 27-61). mRNA, and therefore gene expression data, were not available.

As a control for normal/high BRCA1 expression, gene expression levels of 85 luminal tumors were used from an unrelated study. Breast cancer subtype was determined by gene expression patterns similar to the basal-like tumor subtype as described elsewhere (Kreike B, van Kouwenhove M, Horlings H, Weigelt B, Peterse H, Bartelink H and van de Vijver M J. (2007). Breast Cancer Res, 9, R65.).

As a control group for chromosomal aberrations, twenty-three CGH profiles from sporadic, histological grade III, tumors from previous studies were used (Joosse S A, van Beers E H, Tielen I H, Horlings H, Peterse J L, Hoogerbrugge N, Ligtenberg M J, Wessels L F, Axwijk P, Verhoef S, Hogervorst F B and Nederlof P M. (2008). Breast Cancer Res Treat.) which expressed either one or a combination of the receptors: ER, PR and HER2/neu. This group will be referred to in this Example as “non-basal-like tumors.”

All experiments involving human tissues were conducted with the permission of the medical ethical advisory board of the Netherlands cancer Institute.

DNA Isolation and Array-CGH

All sample material used for the aCGH experiments was formalin-fixed, paraffin-embedded (FFPE) tissue. DNA was extracted and tested for sufficient quality as previously described (Joosse S A, van Beers E H, Tielen I H, Horlings H, Peterse J L, Hoogerbrugge N, Ligtenberg M J, Wessels L F, Axwijk P, Verhoef S, Hogervorst F B and Nederlof P M. (2008); and van Beers E H, Joosse S A, Ligtenberg M J, Fles R, Hogervorst F B, Verhoef S and Nederlof P M. (2006). Br J Cancer, 94, 333-337). Tumor and reference DNA were co-hybridized using Cy5 and Cy3 respectively to a micro array containing a BRCA1 classifier (FIG. 2) comprising 3.5 k BAC/PAC derived DNA segments covering the whole genome with an average spacing of 1 MB, and processed as before (Joosse S A, van Beers E H and Nederlof P M. (2007). BMC Cancer, 7, 43). Micro array data have been deposited in NCBIs Gene Expression Omnibus and are accessible through GEO Series accession number GPL4560.

Aberration Detection and Quantification

To analyze and visualize chromosomal aberrations, we determined breakpoint locations and estimated copy number level using the CGH-segmentation algorithm by Picard et al. (Picard F, Robin S, Lavielle M, Vaisse C and Daudin J J. (2005). BMC Bioinformatics, 6, 27). To call gains and losses and count the number of aberrations, a profile dependent cutoff was used. The average of all thresholds was 0.11.

The association of the frequency of a clone being ‘gained’, ‘lost’, or ‘unchanged’ between different tumors groups was calculated by employing a 3×2 Fisher's exact (FE) test. P-values were not directly corrected for multiple testing since this would be too stringent. Instead, since adjacent BAC clones are highly correlated, a genomic region was called significant when at least 5 adjacent BAC clones are calculated to be significant with p<0.01. Because 3277-24*5=3157 regions can be formed existing of 5 adjacent BAC clones, such a region has to reach a total significance of 0.01/3157=3.17*10-6 when corrected for multiple testing. The probability of finding 5 adjacent BAC clones with p=0.01 is (3277+1)*0.015=3.278-7. Using lesser adjacent probes to define a genomic region increases the likelihood for a false positive above 3.17*10-6. Therefore, for identifying a significant aberration, at least 5 adjacent BAC clones with p<0.01 is sufficient.

Methylation MLPA

Methylation of the BRCA1 promoter, which prevents BRCA1 expression, was investigated using a methylation MLPA kit according to manufacturer's protocol (MRC-Holland, The Netherlands, MS-MLPA kit ME001B).

Quantitative RT-PCR

Assessment of the expression level of BRCA1 was done by Real-time PCR (Q-PCR) as a method independent from the microarray/aCGH data to prevent array based biases. For this, the TaqMan Gene Expression Assay for BRCA1 (#Hs01556193_m1, Applied Biosystems, Foster City, Calif., USA) was used. The reactions were performed according to the manufacturer's protocol with 10 ng cDNA (2 ng/μl) for each sample. Expression levels of β-actin and GAPDH were measured as endogenous controls and cDNA from MCF-7 cells in different dilutions was used to obtain a standard curve. qRT-PCR runs were performed on the 7500 Fast System and analysis were done by using 7500 Fast Real-Time PCR Software version 1.3.1. Expression levels were calculated by the Relative Standard Curve Method.

Results

BRCA1 Expression and Methylation in Basal-Like Sporadic Tumors

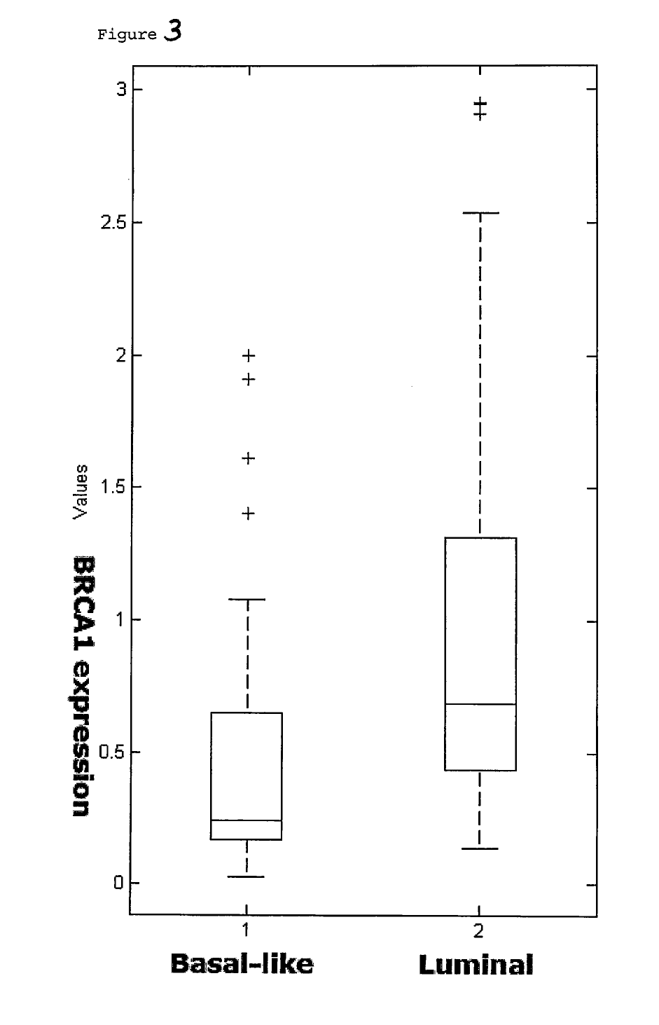

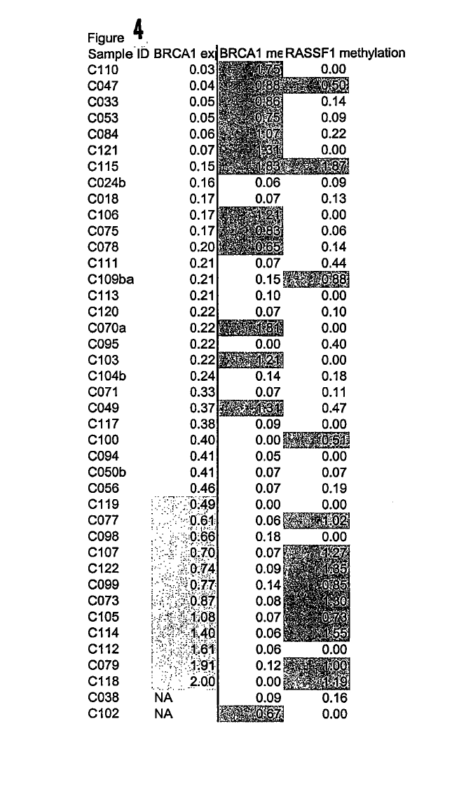

To assess the expression of BRCA1 in sporadic basal-like tumors, mRNA was investigated by Q-PCR. BRCA1 expression was significantly lower in basal-like breast tumors than in luminal control tumors (p=0.0001, unpaired T-test). FIG. 3 shows the distribution of the expression of BRCA1, normalized against the household genes GAPDH and ACTB, individual expression levels are listed in FIG. 4. Median relative expression of BRCA1 in basal-like tumors was 0.24 while this was 0.69 in controls. Since there was no RNA of BRCA1-mutated tumors available as reference for ‘low BRCA1 expression’, the average of these medians (0.47) was used as a cutoff for calling the expression high or low. Employing this cutoff, 69% of the basal-like tumors showed low expression and 31% high expression of BRCA1; these tumors are further referred to in this Example as “basal-likeB1-low” and “basal-likeB1-high” respectively. For the controls, 29% showed low BRCA1 expression.

To investigate one possible reason for the decreased BRCA1 expression, methylation of the BRCA1 promoter was assessed by methylation specific MLPA. Fourteen of the basal-like tumors (36%) proved to carry a methylated BRCA1 promoter. Promoter methylation results in silencing of the gene. Indeed, all cases with a methylated BRCA1 promoter showed low BRCA1 mRNA expression which was significantly correlated (p<2.0*10-5, unpaired T-test). Besides BRCA1, 23 other tumor suppressor genes were simultaneously investigated for promoter methylation. RASSF1 was the second gene which showed significantly more often methylation in the basal-likeB1-high tumors compared to the basal-likeB1-low tumors (p<0.0003, unpaired T-test). These data were comparable with the methylation patterns of BRCA1-mutated tumors in which methylation of the promoter of RASSF1 was also absent. These results indicate that BRCA1 expression is strongly associated with methylation of certain gene promoters.

Level of Chromosomal Imbalance

It is known that histological high grade tumors show a high level of chromosomal imbalance (Reis-Filho J S, Simpson P T, Gale T and Lakhani S R. (2005). Pathol Res Pract, 201, 713-725). To see whether there was a difference in level of chromosomal imbalance between the BRCA1-mutated, basal-likeB1-low, basal-likeB1-high tumor groups and grade III, non-basal-like control tumors, the number of aberrations was counted based on the CGH-segmentation results. Although all basal-like tumors were histological grade III, the basal-likeB1-low group showed significantly fewer aberrations/breakpoints compared with the BRCA1-mutated group. The BRCA1-mutated and the basal-likeB1-high tumor groups showed on average a similar amount of aberrations. Nonetheless, all basal-like and BRCA1-mutated tumors showed on average significantly more aberrations compared to non-basal-like control tumors (Table 5). These results imply that the level of chromosomal imbalance is not only dependant of tumor histological grade.

TABLE 5

| | Number of aberrations | | | | |
|---|---|---|---|---|---|
| Tumor group | Average | Range | Stdev | t-test | p-value |
| BRCA1-mutated (n = 34) | 36.7 | 22-49 | 5.6 | B1 vs BL | 0.013 |
| Basal-like (n = 41) | 33.2 | 23-48 | 6.2 | B1 vs BL^{bl} | 0.0015 |
| Basal-like^{B1-low} (n = 27) | 32.1 | 23-47 | 5.0 | B1 vs BL^{bh} | 0.72 |
| Basal-like^{B1-high} (n = 12) | 37.4 | 32-48 | 6.2 | BL^{bl} vs BL^{bh} | 0.018 |
| Controls (n = 23) | 27.3 | 15-44 | 7.1 | B1 vs C | 3.9*10⁻⁶ |
| | | | | BL vs C | 0.0017 |

Average number of aberrations per tumor group, determined as described before (Joosse 2009).
P-values are calculated between tumor groups using unpaired t-test.
Controls are non-basal-like, grade III tumors from our previous studies (Joosse 2008 + 2009).
B1 = BRCA1-mutated,
BL = Basal-like,
BL^{bl} = basal-likeB1-low,
BL^{bh} = basal-likeB1-high,
C = Control,
Stdev = Standard Deviation.

Copy Number Alterations in Hereditary and Sporadic Breast Tumors

The next analyses were based on the frequency of the copy number alterations. As published before, BRCA1-mutated tumors show a different spectrum of aberrations compared to the general population of sporadic breast cancer (Joosse S A, van Beers E H, Tielen I H, Horlings H, Peterse J L, Hoogerbrugge N, Ligtenberg M J, Wessels L F, Axwijk P, Verhoef S, Hogervorst F B and Nederlof P M. (2008). Breast Cancer Res Treat). BRCA1-mutated tumors also show a different spectrum of aberrations compared to grade III (non-basal-like) sporadic tumors. However, when compared to the sporadic basal-like tumors, BRCA1-mutated breast tumors are very similar. Most of the tumors in both groups show common breast cancer aberrations, i.e. gain of chromosome 1q and 8q and loss of chromosome 8p. Additionally, previously identified aberrations specific to BRCA1-associated, ER negative, or basal-like tumors were found in both groups: gains of regions in chromosome 3q, 6p 9p, 10p, 12p, 21q and losses of regions in chromosome 3p and 5q. However, despite these similarities, several genomic regions were detected with significantly different frequencies between BRCA1-mutated and basal-like tumors (p<0.01). To investigate whether these aberrations were associated with BRCA1 expression, two comparisons were performed.

First, the basal-like tumors were divided into basal-likeB1-low and basal-likeB1-high breast tumors and compared with BRCA1-mutated tumors using similar analysis. Basal-likeB1-low breast tumors were most similar to BRCA1-mutated tumors; only two genomic regions were present in a significantly different frequency. Chromosome 5q14.1-q14.3 and 14q23.3-q24.3 were both less often lost in basal-likeB1-low compared to BRCA1-mutated breast carcinomas. The basal-likeB1-high tumors presented more aberrations in significantly different frequencies, these included 1p21, 3q23-q26, 4p16, 5q14, 12p11, 12q13, 14q11, 15q15, 17p13, 17q12-q21, 19p13, 19q13, 20q11-q12, and 21q21.

For the second comparison, the aberration frequency was employed to the basal-likeB1-low and basal-likeB1-high tumors, which revealed several significant different genomic regions. Chromosome 4p16 and 17q11.2-q12 were more often lost in basal-likeB1-low tumors while chromosome 4q33-q34 was more often lost in basal-likeB1-high tumors. From these 3 regions, chromosome 4p16 was the only aberration that was also found in the comparison between the BRCA1-mutated and basal-likeB1-high tumors.

These results indicate that BRCA1-mutated tumors are quite similar to basal-like tumors, however, differences between these groups are still found. Basal-like tumors that do not express BRCA1 are more like BRCA1-mutated tumors when compared with basal-like tumors that do express BRCA1. Specifically, loss of chromosome 4p16 can be associated with loss of function of BRCA1.

Gene Regulation Associated with BRCA1 Expression

Since aCGH data showed heterogeneity among basal-like tumors based on BRCA1 expression, gene expression data were investigated to assess whether BRCA1 expression also relates to different gene expression patterns in basal-like tumors. Differentially expressed genes in basal-like tumors not expressing BRCA1 (or expressing BRCA1 in low degree) could reveal biological processes associated with BRCA1 deficiency. Additionally, gene expression patterns in basal-like tumors highly expressing BRCA1, could reveal something about the differences within the basal-like tumor group.

To evaluate statistical significance of the gene expression patterns between basal-likeB1-low and basal-likeB1-high tumors, the Significance Analysis of Microarrays (SAM) method was employed. For a false discovery rate (FDR) of 9.7%, delta was 0.49 and the tail-strength was 0.26. Ninety-eight genes were found to be significantly down-regulated in the basal-likeB1-low compared with the basal-likeB1-high tumors. DAVID analysis was used to obtain Gene Ontology (GO) annotations for the category ‘biologic process’. The selected genes were enriched in the GO term ‘Developmental Processes’ (GO:0032502; p=0.0063). To investigate whether these genes could also separate the basal-like subgroups from each other, the Prediction Analysis for Microarrays (PAM) method was employed based on the selected genes only. Leave-one-out-cross-validation (LOOCV) resulted in misclassification error of 30%, indicating a poor separation.

The next analysis was based on gene expression levels in combination with array-CGH data. Along the regions of chromosome 4 and 17 that were found to be differently aberrated between basal-likeB1-low and basal-likeB1-high tumors, fourteen genes were also found to be significantly (p<0.05) differentially expressed (Table 6).

TABLE 6

| gene | P-value | chr |
|---|---|---|
| HTRA3 | 0.0213 | 4p16.1 |
| WDR1 | 0.0076 | 4p16.1 |
| MSX1 | 0.0488 | 4p16.2 |
| MAEA | 0.0160 | 4p16.3 |
| ATP5I | 0.0226 | 4p16.3 |
| C4orf15 | 0.0288 | 4p16.3 |
| VEGFC | 0.0031 | 4q34.3 |
| DDX52 | 0.0223 | 17q12 |
| ACACA | 0.0279 | 17q12 |
| ZNF403 | 0.0227 | 17q12 |
| TAF15 | 0.0269 | 17q12 |
| AP2B1 | 0.0210 | 17q12 |
| MRPL45 | 0.0045 | 17q12 |
| AATF | 0.0317 | 17q12 |

Discussion

Breast carcinomas that are negative for ER, PR, and HER2 and that are identified as basal-like are a distinct breast cancer subgroup with often a poor prognosis. Literature describing the relationship between BRCA1-pathway deficiency and basal-like breast cancer has been increasing rapidly in the last few years (Turner N C and Reis-Filho J S. (2006). Oncogene, 25, 5846-5853; Rakha E A, Reis-Filho J S and Ellis I O. (2008). J Clin Oncol, 26, 2568-2581; Reis-Filho J S and Tutt A N. (2008). Histopathology, 52, 108-118; and Melchor L and Benitez J. (2008). Carcinogenesis, 29, 1475-1482). Because of this deficiency, it is not surprising that basal-like and BRCA1-mutated breast tumors are alike in many aspects. It would be clinically and biologically relevant to identify the exact similarities between these groups which could lead to the identification of common therapeutic targets. Several studies have investigated the chromosomal aberrations in sporadic basal-like (Bergamaschi A, Kim Y H, Wang P, Sorlie T, Hernandez-Boussard T, Lonning P E, Tibshirani R, Borresen-Dale A L and Pollack J R. (2006). Genes Chromosomes Cancer, 45, 1033-1040; and Vincent-Salomon A, Gruel N, Lucchesi C, MacGrogan G, Dendale R, Sigal-Zafrani B, Longy M, Raynal V, Pierron G, de Mascarel I, Tanis C, Stoppa-Lyonnet D, Pierga J Y, Salmon R, Sastre-Garau X, Fourquet A, Delattre O, de Cremoux P and Aurias A. (2007). Breast Cancer Res, 9, R24) and in BRCA1-mutated tumors (Tirkkonen M, Johannsson O, Agnarsson B A, Olsson H, Ingvarsson S, Karhu R, Tanner M, Isola J, Barkardottir R B, Borg A and Kallioniemi O P. (1997). Cancer Res, 57, 1222-1227; Wessels L F, van Welsem T, Hart A A, van't Veer L J, Reinders M J and Nederlof P M. (2002). Cancer Res, 62, 7110-7117; van Beers E H, van Welsem T, Wessels L F, Li Y, Oldenburg R A, Devilee P, Cornelisse C J, Verhoef S, Hogervorst F B, van't Veer L J and Nederlof P M. (2005). Cancer Res, 65, 822-827; Joosse S A, van Beers E H, Tielen I H, Horlings H, Peterse J L, Hoogerbrugge N, Ligtenberg M J, Wessels L F, Axwijk P, Verhoef S, Hogervorst F B and Nederlof P M. (2008). Breast Cancer Res Treat; and Jonsson G, Naylor T L, Vallon-Christersson J, Staaf J, Huang J, Ward M R, Greshock J D, Luts L, Olsson H, Rahman N, Stratton M, Ringner M, Borg A and Weber B L. (2005). Cancer Res, 65, 7612-7621) separately. These studies show gain along chromosome 3q and 10p and loss along chromosome 5q to be the most common aberrations among both groups. This has led to the presumption that these tumor groups are similar in respect to their chromosomal aberrations (Turner N C and Reis-Filho J S. (2006). Oncogene, 25, 5846-5853). However, in-depth analysis of the results of these studies also shows many discrepancies. We note that Differences between the designs of the aforementioned studies make it difficult to compare results between them and make it difficult to locate the exact chromosomal boundaries of the aberrations that the two tumor groups share. Therefore, verified BRCA1-mutated breast carcinomas were used in this Example and compared those with sporadic breast tumors that were defined by gene expression profiling as basal-like and histologically similar. Additionally, these tumors were studied using identical reference material and detection methods and sub-grouped them based on the expression of BRCA1.

The basal-like tumor group showed significantly lower expression of BRCA1 than unrelated, non-basal-like breast tumors on average. Although a low, basic level of BRCA1 expression exists in normal breast epithelial cells, a ‘normal’ level of BRCA1-expression in (breast) cancer in general doesn't really exist. Therefore, an arbitrary cut off was defined for low and high BRCA1 expression, based on the medians of the expression levels of the basal-like and non-basal-like tumor groups. This cut off might not reflect the exact biological high or low expression for BRCA1, however it does separate the basal-like samples which could be well correlated to other findings reported herein. Using the BRCA1 expression cutoff, 31% of the basal-like tumors were identified with a high BRCA1 gene expression level. The tumor set of Turner et al. shows that a part (14%) of basal-like tumors (divined as Ck5/6 positive) express a higher level of BRCA1 (Turner N C, Reis-Filho J S, Russell A M, Springall R J, Ryder K, Steele D, Savage K, Gillett C E, Schmitt F C, Ashworth A and Tutt A N. (2007). Oncogene, 26, 2126-2132), based on a similar analysis performed using their data. The expression of BRCA1 was associated with methylation of the BRCA1 promoter in the data set obtained for this Example, a finding that has been described elsewhere. Although there are some minor differences between the results of these studies and the results presented in this Example, it is believed that such differences are only the result of the choice of basal-like definition and control group. An additional finding in the instant methylation study in basal-like tumors was that the promoter of RASSF1 was rarely methylated in the basal-likeB1-low tumors, just like in BRCA1-mutated tumors. Basal-likeB1-high tumors on the other hand, generally show methylation of the RASSF1 promoter, which has also been seen in sporadic tumors to occur more often than in BRCA1-associated tumors. This indicates that the methylation pattern of the RASSF1 promoter is strongly associated with BRCA1 expression, whether BRCA1 is dysfunctional by mutation, methylation, or other processes, seems to not be important.

An unexpected result was that the number of breakpoints in basal-likeB1-low tumors was much lower than in BRCA1-mutated tumors, while basal-likeB1-high tumors showed on average many more aberrations, similar to that of the BRCA1-mutated tumors. It is believed that this is due to the differences in the process of tumorigenesis in these tumor types. Since presumably BRCA1 is lost in sporadic (basal-likeB1-low) tumors in a later stage of tumorigenesis than in BRCA1 germline mutated tumors, these tumors undergo less stress and therefore less chromosomal breaks.

Frequency plot analysis of the chromosomal aberrations of basal-like and BRCA1-mutated tumors showed similar profiles, compared to the many differences found between sporadic non-basal-like and BRCA1-mutated tumors. This was expected since basal-like and BRCA1-mutated tumors are also pathologically similar, while non-basal-like tumors are quite different in this respect. Separating the basal-like tumors based on BRCA1 gene expression, the basal-likeB1-low breast tumors were more like the BRCA1-mutated tumors than the basal-likeB1-high tumors were. Comparison between basal-likeB1-high and basal-likeB1-low tumors showed some differences. One of these differences, located on chromosome 4p16, was also found to be different between basal-likeB1-high and BRCA1-mutated tumors. This would suggest that loss of chromosome 4p16 is specific for BRCA1-deficiency in hereditary but also sporadic basal-like breast cancer. Loss of heterozygosity at chromosome 4p16 has been earlier studied in relation with the tumor suppressor gene FGFR3 in bladder cancer.

In previous studies, gain of chromosome 3q has been identified to be an important marker of BRCA1-mutated tumors compared to sporadic tumors (Joosse S A, van Beers E H, Tielen I H, Horlings H, Peterse J L, Hoogerbrugge N, Ligtenberg M J, Wessels L F, Axwijk P, Verhoef S, Hogervorst F B and Nederlof P M. (2008). Breast Cancer Res Treat; and Wessels L F, van Welsem T, Hart A A, van't Veer L J, Reinders M J and Nederlof P M. (2002). Cancer Res, 62, 7110-7117). In this Example, it has been shown that gain of chromosome 3q23-q26 is present in hereditary, but also in sporadic basal-like, BRCA1 deficient tumors. However, it is not present in such a high frequency in basal-like sporadic tumors expressing BRCA1.

A previous study performed on the gene expression data of these basal-like tumors revealed five different subgroups using unsupervised clustering (Kreike B, van Kouwenhove M, Horlings H, Weigelt B, Peterse H, Bartelink H and van de Vijver M J. (2007). Breast Cancer Res, 9, R65). Supervised analysis based on BRCA1 expression revealed many genes downregulated upon low expression of BRCA1. However, since these genes were enriched in the GO term ‘Developmental Processes’, which is a very broad biological process, and the tail strength of the SAM analysis was weak, the meaning of the results is unclear. With respect to the gene expression patterns of the genes along chromosome 4p16, only the down regulation of gene WDR1 was significantly correlated (p<0.01) to the loss of this region.

Concluding, since most basal-like tumors originate from the same cell layer, their genomic profile is generally quite similar, whether they are hereditary or sporadic breast tumors. During tumorigenesis, a fraction of the sporadic basal-like tumors lose BRCA1 by, e.g., methylation of the promoter. This leads to the additional loss of chromosome 4p16 and to the gain of chromosome 3q23-q26, which remain absent in basal-like tumors which do not suppress expression of BRCA1.

### Example 3

To determine whether the BRCA1-classifier disclosed herein (FIG. 2) predicts benefit from HD-chemotherapy, two patient series were studied. First, patients with metastatic breast cancer (MBC) who had received HD-chemotherapy (5-fluorouracil, epirubicin, cyclophosphamide (FEC) as induction followed by high dose cyclophosphamide, thiotepa and carboplatin (CTC) with autologous stem cell support) were studied. A cut-off of the BRCA1-probability score of the BRCA1-classifier was determined for this patient series. Because all patients in this series received HD-chemotherapy, it was not possible to determine whether the BRCA1-classifier was predictive for therapy benefit (predictive marker) or for survival (prognostic marker). To validate the cut-off and determine whether the BRCA1-classifier was a predictive marker, stage III breast cancer patients were studied in the adjuvant setting who had been randomized to either conventional or HD-chemotherapy (CTC) with autologous stem cell support. All trials were approved by the Institutional Review board of the Netherlands Cancer Institute.

Patient Selection and Study Design First Series (MBC Series)

Patients were included from three pilot studies carried out at the Netherlands Cancer Institute between 1993 and 2004 (one patient was included in 1989 with the setup of the trial). Inclusion criteria have been published previously.

Patients were eligible when their formalin-fixed paraffin-embedded (FFPE) primary tumor tissue contained more than 60% of tumor cells and when they had received at least one course of CTC. Exclusion criteria consisted of progressive disease on induction chemotherapy (FEC), as these patients did not proceed to HD-chemotherapy; treatment-related death; contralateral breast cancer; stage IIIc26 breast cancer.

Patient Selection Second Series (Stage-III Series)

Patients of the second series were selected from a large randomized controlled multicentre trial performed in the Netherlands between 1993 and 1999. Inclusion criteria have been published previously. Eligible patients were randomized between either conventional chemotherapy (five courses FEC), or HD-chemotherapy which was identical except that instead of the fifth course of FEC, a course of CTC was given. Based on the observation that BRCA1-like tumors virtually always have a low ER and negative HER2 expression and comprise about 30-50% of all ER-low, HER2-negative tumors, patients with tumors with a low ER expression (<25%) and a HER2-negative status were studied in this randomized trial. Cases were only included when their FFPE primary tumor tissue was available and contained more than 60% of tumor cells.

Comparative Genomic Hybridization and Mutation Analyses

Genomic DNA was extracted from all FFPE primary tumors as previously described. Of seven patients only lymph node tissue, removed at first diagnosis containing primary tumor tissue, was available. Tumor DNA and reference DNA were labeled and hybridized as published previously. The data discussed in this Example have been deposited in NCBI's Gene Expression Omnibus and are accessible through GEO Series accession number GSE12127.

A BRCA1-classifier (FIG. 2) was constructed and refined for two purposes; 1) to use as a pre-selection tool to detect subjects with a high risk of carrying a BRCA1-mutation, which resulted in a slightly modified version; and 2) to use as a predictive test to identify breast cancer patients likely to benefit from DSB-inducing agents. For the latter, the BRCA1 classifier was used as described herein. BRCA1 class detection was performed on each individual aCGH tumor profile using the BRCA1-classifier (FIG. 2), resulting in a BRCA1-probability score ranging from 0 to 1. All protocols used for aCGH have been previously described (Vollebergh, M. A., Lips E. H., Nederlof, P. M., et al. An aCGH classifier derived from BRCA1-mutated breast cancer and benefit of high-dose platinum-based chemotherapy in HER2-negative breast cancer patients, Ann Oncol, 2010, in press).

For mutation analysis, a method developed especially for DNA isolated from FFPE material was used (Vollebergh, M. A., Lips E. H., Nederlof, P. M., et al. An aCGH classifier derived from BRCA1-mutated breast cancer and benefit of high-dose platinum-based chemotherapy in HER2-negative breast cancer patients, Ann Oncol, 2010, in press). The most common mutations reported in Dutch families known to carry pathogenic germline BRCA1 or BRCA2 mutations were screened for. The analysis included 37 distinct BRCA1 mutations accounting for 749 of 1166 BRCA1 families (−64%) and 40 distinct BRCA2 mutations accounting for 264 of 520 BRCA2 families (−51%) in the Netherlands.

Histopathology

Two pathologists (JW and MvdV) reviewed all tumors and scored whole H&E-slides for tumor percentages. ER, HER2 and progesterone receptor status was determined by immunohistochemistry (IHC) as described before (Rodenhuis S, Bontenbal M, Beex L V et al. High-dose chemotherapy with hematopoietic stem-cell rescue for high-risk breast cancer. N Engl J Med 2003; 349(1):7-16; and Nielsen T O, Hsu F D, Jensen K et al. Immunohistochemical and clinical characterization of the basal-like subtype of invasive breast carcinoma. Clin Cancer Res 2004; 10(16):5367-5374.) Pronase was used as pretreatment for EGFR (EGFR Ab-10 clone 111.6; 1:200; Neomarkers; EGFR clone 31G7, 1:400; Zymed) and the standard procedure for CK 5/6 (clone D5/16 B4, M7237, 1:200, Dako). CK5 and EGFR were considered positive if any (weak or strong) staining of tumor cells was observed. Tumors were classified as basal-like according to the Nielsen basal-like breast cancer IHC definition, as published previously (Van De Vijver M J, Peterse J L, Mooi W J et al. Neu-protein overexpression in breast cancer. Association with comedo-type ductal carcinoma in situ and limited prognostic value in stage II breast cancer. N Engl J Med 1988; 319(19):1239-1245.)

Statistical Analysis

The cut-off of the BRCA1-probability score on the MBC series was determined to obtain the highest positive predictive value for response (defined as a progression free survival (PFS) longer than 24 months, the median overall survival of MBC patients) and validated in the stage-III series.

Differences between groups of interest were tested using Fisher's exact tests and exact Chi-square test for trends. Patients with missing values for a variable were excluded from analyses involving that variable. Survival curves were generated using the Kaplan-Meier method and compared using the log-rank test. Hazard ratios (HR) were calculated using Cox proportional hazards regression.

In the MBC series, complete remission after CTC-treatment was defined as disappearance of all evaluable tumor mass assessed by physical examination and imaging studies. PFS was defined as the time from the first CTC-course to the appearance of the first progression of disease (based on clinical signs and symptoms, substantiated with imaging and/or biochemical analyses and/or cytology/histology), or death, whichever occurred earlier. Patients who did not experience a progression were censored at the end of follow-up. Because of the small sample size, potential confounders were not added at once, but rather one at a time to a model including the BRCA1-classifier.

In the stage-III series, recurrence free survival (RFS) was calculated from randomization to the appearance of a local or regional recurrence, metastases or to death from any cause (Rodenhuis S, Bontenbal M, Beex L V et al. High-dose chemotherapy with hematopoietic stem-cell rescue for high-risk breast cancer. N Engl J Med 2003; 349(1):7-16.). All other events were censored. Overall survival (OS) was time from randomization to death from any cause, or end of follow-up. Patients alive at their last follow-up visit at the time of analysis were censored at that time. All treatment comparisons were based on patients who completed their assigned treatment (per-protocol analysis). The effect of HD-chemotherapy versus conventional chemotherapy on RFS, expressed as hazard ratio (HR), was assessed to determine whether it differed by BRCA1-like status based on multivariate proportional hazards regression with an interaction term, adjusting for potential confounders.

All calculations were performed using the statistical package SPSS 15.0 and SAS 9.1 (for Windows, respectively SAS Institute Inc., Cary, N.C., USA).

Results

MBC Series

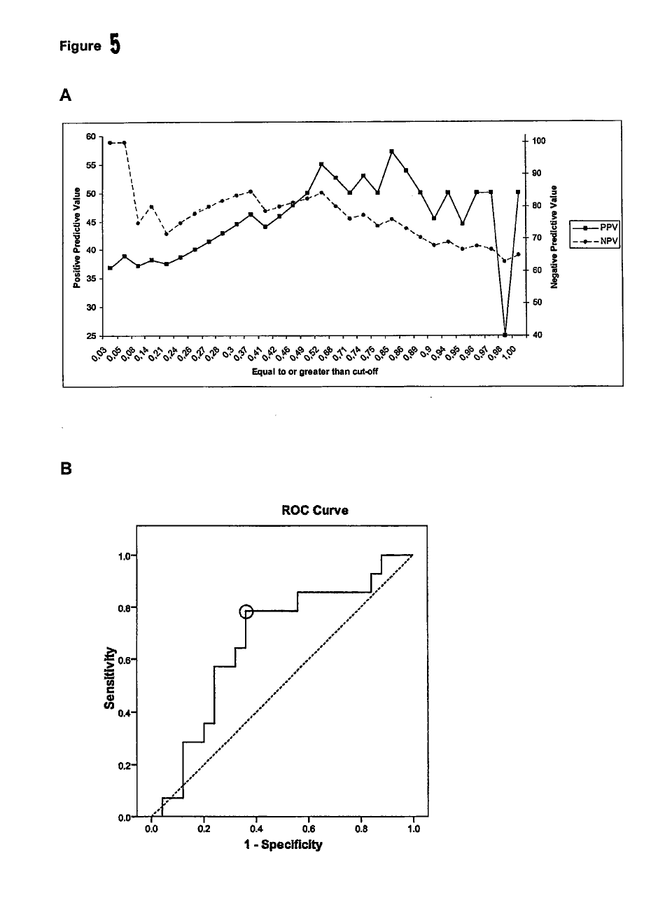

Based on aCGH-profiles of 84 patients, tumors with a BRCA1-probability score >0.84 (FIG. 5) were considered BRCA1-like and others as Sporadic-like. Compared with Sporadic-like tumors, BRCA1-like tumors were more often HER2-receptor negative (p=0.06), ER-negative (p=0.02), and basal-like (p<0.001) (Table 7).

TABLE 7
Metastatic set: characteristics by profile (191 BAC cut-off 0.84)

| | Scored as Sporadic-like | | | Scored as BRCA1-like | | | |
|---|---|---|---|---|---|---|---|
| Variable | n | % | | n | % | | p-value |
| Total | 39 | | 100 | | | | |
| Age at CTC | | | | | | | |
| Mean (years) - range | 44.8 - 23-59.5 | | | 41.7 - 32.6-51 | | | 0.242 |
| ≦40 years | | 8 | 32.0 | | 7 | 50.0 | 0.318 |
| >40 years | | 17 | 68.0 | | 7 | 50.0 | |
| Metastatic disease | | | | | | | |
| ≦2 sites of metastases | | 12 | 48.0 | | 10 | 71.4 | 0.193 |
| >2 sites of metastases | | 13 | 52.0 | | 4 | 28.6 | |
| Histological grade | | | | | | | |
| Grade 1 and 2 | | 10 | 40.0 | | 3 | 21.4 | 0.304 |
| Grade 3 | | 15 | 60.0 | | 11 | 78.6 | |
| HER2 receptor | | | | | | | |
| Negative | | 16 | 64.0 | | 14 | 100.0 | 0.015 |
| Positive | | 9 | 36.0 | | 0 | 0.0 | |
| Estrogen receptor status | | | | | | | |
| Negative | | 12 | 48.0 | | 13 | 92.9 | 0.006 |
| Positive | | 13 | 52.0 | | 1 | 7.1 | |
| Progesterone receptor status | | | | | | | |
| Negative | | 12 | 48.0 | | 11 | 78.6 | 0.412 |
| Positive | | 6 | 24.0 | | 2 | 14.3 | |
| Unknown | | 7 | 28.0 | | 1 | 7.1 | |
| CK 5/6 status | | | | | | | |
| Negative | | 23 | 92.0 | | 7 | 50.0 | 0.005 |
| Positive | | 2 | 8.0 | | 7 | 50.0 | |
| EGFR status | | | | | | | |
| Negative | | 21 | 84.0 | | 7 | 50.0 | 0.014 |
| Positive | | 2 | 8.0 | | 7 | 50.0 | |
| Unknown | | 2 | 8.0 | | 0 | 0.0 | |
| Basal Nielsen score | | | | | | | |
| Negative | | 23 | 92.0 | | 6 | 42.9 | 0.001 |
| Positive | | 2 | 8.0 | | 8 | 57.1 | |
| Prior Chemotherapy | | | | | | | |
| No | | 15 | 60.0 | | 12 | 85.7 | 0.151 |
| Yes | | 10 | 40.0 | | 2 | 14.3 | |
| Prior Radiotherapy | | | | | | | |
| No | | 6 | 24.0 | | 4 | 28.6 | 1.000 |
| Yes | | 19 | 76.0 | | 10 | 61.4 | |
| Number of CTC courses | | | | | | | |
| <3 courses | | 10 | 40.0 | | 2 | 14.3 | 0.151 |
| 3 courses | | 15 | 60.0 | | 12 | 85.7 | |
| CTC Response | | | | | | | |
| All other responses | | 15 | 60.0 | | 2 | 14.3 | 0.008 |
| Complete Remission | | 10 | 40.0 | | 12 | 85.7 | |
| PFS | | | | | | | |
| Range (months) | 1.6-101.9 | | | 3.9-146.7 | | | 0.017 |
| Median (months) | 9.7 | | | 30.8 | | | |
| Overall survival | | | | | | | |
| Range (months) | 4.7-107.8 | | | 7.5-146.7 | | | 0.143 |
| Median (months) | 20.9 | | | 49.1 | | | |

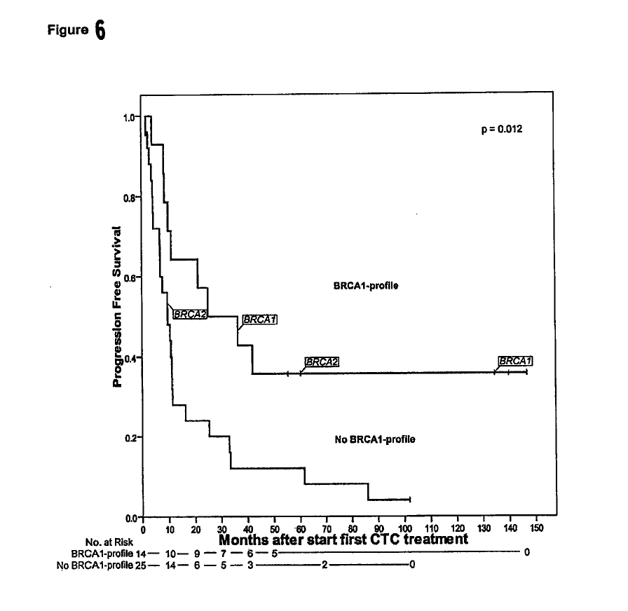

BRCA1-like patients had a significantly better response to CTC-treatment, defined by achievement of complete remission (p=0.02), and significantly longer PFS (FIG. 6, p=0.001), with a univariate HR for progression of 0.31 (95% CI: 0.14-0.66, Table 8). Adjustment for potential confounders did not substantially modify the HR (Table 9).

TABLE 8
Univariate Cox proportional-hazard regression analysis of the risk of tumor
progression (PFS) after HD-chemotherapy treatment in the MBC-series

| Variable | Hazard Ratio | 95% CI | p-value |
|---|---|---|---|
| aCGH classifier | | | |
| Non-BRCA1-like tumor | 1.00 | | |
| BRCA1-like tumor | 0.38 | 0.18-0.83 | 0.015 |
| Estrogen Receptor status^{†} | | | |
| Negative | 1.00 | | |
| Positive | 1.05 | 0.52-2.13 | 0.885 |
| HER2-receptor status^{†} | | | |
| Negative | 1.00 | | |
| Positive | 1.74 | 0.80-3.79 | 0.163 |
| Nielsen basal-like breast | | | |
| cancer definition^{†} | | | |
| Negative | 1.00 | | |
| Positive | 0.49 | 0.21-1.14 | 0.099 |
| Histological grade^{†} | | | |
| 1 (good)/2 (intermediate) | 1.00 | | |
| 3 (poor) | 0.98 | 0.47-2.03 | 0.957 |
| Prior Chemotherapy^{‡} | | | |
| No | 1.00 | | |
| Yes | 2.39 | 1.14-4.98 | 0.020 |
| Prior Radiotherapy | | | |
| No | 1.00 | | |
| Yes | 2.81 | 1.13-7.00 | 0.026 |
| Age at CTC* | | | |
| ≦40 years | 1.00 | | |
| >40 years | 1.15 | 0.56-2.38 | 0.709 |
| Metastatic disease* | | | |
| ≦2 sites of metastases | 1.00 | | |
| >2 sites of metastases | 2.14 | 1.04-4.37 | 0.038 |
| Site of metastases* | | | |
| Other | 1.00 | | |
| Soft tissue metastases only^{§} | 0.46 | 0.22-0.96 | 0.037 |
| Site of metastases* | | | |
| Other | 1.00 | | |
| Visceral metastases only | 1.11 | 0.26-4.73 | 0.887 |
| Site of metastases* | | | |
| Other | 1.00 | | |
| Bone metastases only | 1.73 | 0.51-5.80 | 0.377 |
| Number of CTC courses | | | |
| <3 courses | 1.00 | | |
| 3 courses | 0.36 | 0.18-0.75 | 0.006 |
| Local Treatment after CTC | | | |
| No | 1.00 | | |
| Yes | 0.28 | 0.13-0.58 | 0.001 |

*at start first CTC treatment.
^{†}Of primary tumor, except for two patients of whom only the lymph node metastasis tissue of the primary tumor was available.
^{‡}Prior chemotherapy, in all cases consisted of cyclophosphamide, methotrexate and fluoruracil (CMF) in the adjuvant setting, except one case who received five courses of adjuvant FE₉₀C.
^{§}Soft tissue metastases consisted of locoregional disease, lymph node metastasis and skin metastasis.
Abbreviations:
CI, confidence interval;
CTC, carboplatin-thiotepa-cyclophosphamide.

TABLE 9
Multivariate Cox proportional-hazard regression analysis of the risk of tumor
progression (PFS) after HD-chemotherapy treatment in the MBC-series

| | No. | | 95% | | | No. | | 95% | |
|---|---|---|---|---|---|---|---|---|---|
| Variable | Event | Hazard | Cl | P-val | Variable | Event | Hazard | Cl | P-val |
| Estrogen Receptor | | | | | Prior | | | | |
| Status^{†} | | | | | Radiotherapy | | | | |
| Negative | 20 | 1.00 | — | | No | 6 | 1.00 | — | |
| Positive | 13 | 0.55 | 0.25- | 0.132 | Yes | 27 | 2.42 | 0.98- | 0.056 |
| | | | 1.20 | | | | | 6.01 | |
| | | | | | aCGH | | | | |
| aCGH classifier | | | | | classifier | | | | |
| Non-BRCA1-like tumor | 24 | 1.00 | — | | Non-BRCA1 | 24 | 1.00 | — | |
| | | | | | like tumor | | | | |
| BRCA1-like tumor | 9 | 0.28 | 0.12- | 0.004 | BRCA1-like | 9 | 0.43 | 0.20- | 0.034 |
| | | | 0.66 | | tumor | | | 0.94 | |
| HER2 receptor | | | | | Prior | | | | |
| status^{†} | | | | | Chemotherapy^{‡} | | | | |
| Negative | 24 | 1.00 | — | | No | 21 | 1.00 | — | |
| Positive | 9 | 1.13 | 0.49- | 0.777 | Yes | 12 | 1.78 | 0.82- | 0.144 |
| | | | 2.60 | | | | | 3.85 | |
| | | | | | aCGH | | | | |
| aCGH classifier | | | | | classifier | | | | |
| Non-BRCA1-like tumor | 24 | 1.00 | — | | Non-BRCA1 | 24 | 1.00 | — | |
| | | | | | like tumor | | | | |
| BRCA1-like tumor | 9 | 0.40 | 0.17- | 0.031 | BRCA1-like | 9 | 0.46 | 0.20- | 0.062 |
| | | | 0.92 | | tumor | | | 1.04 | |
| Nielsen basal-like | | | | | Number of | | | | |
| breast cancer | | | | | CTC | | | | |
| definition^{†} | | | | | courses | | | | |
| Negative | 26 | 1.00 | — | | <3 courses | 12 | 1.00 | — | |
| Positive | 7 | 0.75 | 0.29- | 0.551 | 3 courses | 21 | 0.47 | 0.22- | 0.050 |
| | | | 1.94 | | | | | 1.00 | |
| | | | | | aCGH | | | | |
| aCGH classifier | | | | | classifier | | | | |
| Non-BRCA1-like tumor | 24 | 1.00 | — | | Non-BRCA1- | 24 | 1.00 | — | |
| | | | | | like tumor | | | | |
| BRCA1-like tumor | 9 | 0.43 | 0.18- | 0.059 | BRCA1-like | 9 | 0.47 | 0.21- | 0.072 |
| | | | 1.03 | | tumor | | | 1.07 | |
| | | | | | Local | | | | |
| | | | | | treatment after | | | | |
| Metastatic disease* | | | | | CTC | | | | |
| ≦2 sites of metastases | 17 | 1.00 | — | | No | 18 | 1.00 | — | |
| >2 sites of metastases | 16 | 1.65 | 0.78- | 0.188 | Yes | 15 | 0.35 | 0.16- | 0.011 |
| | | | 3.45 | | | | | 0.79 | |
| | | | | | aCGH | | | | |
| aCGH classifier | | | | | classifier | | | | |
| Non-BRCA1-like tumor | 24 | 1.00 | — | | Non-BRCA1- | 24 | 1.00 | — | |
| | | | | | like tumor | | | | |
| BRCA1-like tumor | 9 | 0.45 | 0.20- | 0.052 | BRCA1-like | 9 | 0.57 | 0.24- | 0.191 |
| | | | 1.01 | | tumor | | | 1.33 | |
| Site of metastases* | | | | | | | | | |
| Other | 21 | 1.00 | — | | | | | | |
| Soft tissue metastases | 12 | 0.52 | 0.25- | 0.078 | | | | | |
| only^{§} | | | 1.08 | | | | | | |
| aCGH classifier | | | | | | | | | |
| Non-BRCA1-like tumor | 23 | 1.00 | — | | | | | | |
| BRCA1-like tumor | 10 | 0.42 | 0.19- | 0.029 | | | | | |
| | | | 0.91 | | | | | | |

*at start first CTC treatment.
^{†}Of primary tumor, except for two patients of whom only the lymph node metastasis tissue of the primary tumor was available.
^{‡}Prior chemotherapy, in all cases consisted of cyclophosphamide, methotrexate and fluoruracil (CMF) in the adjuvant setting, except one case who received five courses of adjuvant FE₉₀C.
^{§}Soft tissue metastases consisted of locoregional disease, lymph node metastasis and skin metastasis.
Abbreviations:
Cl, confidence interval;
CTC, carboplatin-thiotepa-cyclophosphamide.

MBC Series and Mutation Analysis

Two BRCA1-mutated tumors were identified, both of which had a BRCA1-like tumor. Mutations were not necessarily germ-line mutations, since DNA derived from the tumors was tested. Three of the four BRCA-mutated patients identified in this analysis had been tested by the familial cancer clinic and were known mutation carriers. The familial cancer clinic had tested one additional patient of this study, who was found to be wild type BRCA1 in both this and their analysis. For a single patient, all DNA was used for aCGH and mutation analyses could not be performed.

Stage-III Series

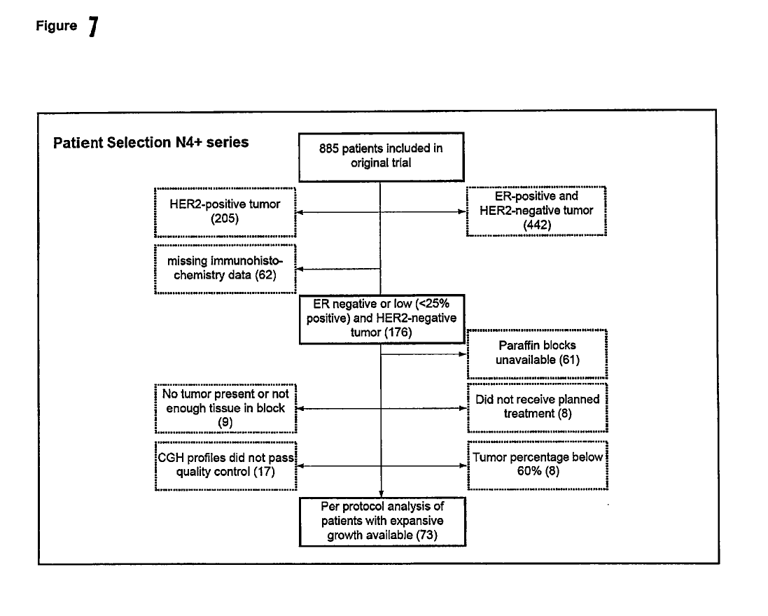

FIG. 7 summarizes the flow of patients through the study including the number of patients in each stage. Reasons for dropout are listed. Tumor aCGH profiles could be obtained for 73 patients. Characteristics and treatments of these 73 patients did not differ from those of the ER-low, HER2-negative patients not in the current analysis.

Of the 73 patients, 30 tumors (41%) were scored as BRCA1-like. Patient characteristics did not differ by treatment arm within the patients with BRCA1- or Sporadic-like tumors. Patients with BRCA 1-like tumors were generally younger, and their tumors were more often poorly differentiated and progesterone receptor negative. Tumor size according to TNM classification, number of positive lymph nodes and treatment were significantly associated with RFS and therefore included in multivariate analyses as potential confounders.

Finally, it should be noted that there are alternative ways of implementing the embodiments disclosed herein. Accordingly, the present embodiments are to be considered as illustrative and not restrictive. Furthermore, the claims are not to be limited to the details given herein, and are entitled their full scope and equivalents thereof.

1. A method for predicting a patient's response to anti-cancer therapy, comprising:
obtaining a test sample from the patient;
detecting the copy numbers of DNA in the test sample in at least one genomic locus selected from 1p34-21, 3p21, 3q22-27, 5q13-15, 5q21-23, 6p23-22, 10p14, 12q21-23, 13q31-33, and 14q22-24; and
comparing the copy numbers in the test sample to corresponding copy numbers in a reference sample;
wherein a variation in the copy numbers in the test sample indicates that the patient will benefit from anti-cancer therapy.

2. The method of claim 1, wherein an increase in the copy numbers in the test sample in at least one genomic locus selected from 1p34-21, 3q22-27, 6p23-22, 10p14 and 13q31-33 indicates that the patient will benefit from anti-cancer therapy.

3. The method of claim 2, wherein an increase in the copy numbers in the test sample is detected in the genomic loci 1p34-21, 3q22-27, 6p23-22, 10p14 and 13q31-33 indicates that the patient will benefit from anti-cancer therapy.

4. The method of claim 1, wherein a decrease in the copy numbers in the test sample in at least one genomic locus selected from 3p21, 5q13-15, 5q21-23, 12q21-23 and 14q22-24 indicates that the patient will benefit from anti-cancer therapy.

5. The method of claim 4, wherein a decrease in the copy numbers in the test sample in the genomic loci 3p21, 5q13-15, 5q21-23, 12q21-23 and 14q22-24 indicates that the patient will benefit from anti-cancer therapy.

6. The method of claim 1, wherein a variation in the copy numbers in the test sample in the genomic loci 1p34-21, 3p21, 3q22-27, 5q13-15, 5q21-23, 6p23-22, 10p14, 12q21-23, 13q31-33, and 14q22-24 indicates that the patient will benefit from anti-cancer therapy.

7. The method of claim 1, wherein an increase in the copy numbers in the test sample in the genomic loci 1p34-21, 3q22-27, 6p23-22, 10p14 and 13q31-33; and a decrease in the copy numbers in the test sample in the genomic loci 3p21, 5q13-15, 5q21-23, 12q21-23 and 14q22-24 indicates that the patient will benefit from anti-cancer therapy.

8. The method of claim 1, wherein the anti-cancer therapy is selected from administration of homologous recombination deficiency-targeted drugs, drugs that directly cause double strand DNA breaks, and drugs that indirectly cause double strand DNA breaks.

9. The method of claim 1, wherein the detecting is performed by array comparative genomic hybridization using an array.

10. The method of claim 9, wherein the array comprises a plurality of probes immobilized on a substrate, wherein the probes hybridize to DNA from at least one genomic locus selected from 1p34-21, 3p21, 3q22-27, 5q13-15, 5q21-23, 6p23-22, 10p14, 12q21-23, 13q31-33, and 14q22-24.

11. The method of claim 10, wherein the probes hybridize to DNA from the genomic loci 1p34-21, 3q22-27, 6p23-22, 10p14 and 13q31-33.

12. (canceled)

13. The method of claim 10, wherein the probes hybridize to DNA from the genomic loci 3p21, 5q13-15, 5q21-23, 12q21-23 and 14q22-24.

14. (canceled)

15. The method of claim 10, wherein the probes hybridize to DNA from the genomic loci 1p34-21, 3p21, 3q22-27, 5q13-15, 5q21-23, 6p23-22, 10p14, 12q21-23, 13q31-33, and 14q22-24.

16. (canceled)

17. The method of claim 10, wherein the array comprises a plurality of probes derived from at least one of the BAC clones of FIG. 2.

18. The method of claim 10, wherein the probes are derived from at least 50 of the BAC clones of FIG. 2.

19. The method of claim 10, wherein the probes are derived from all 191 of the BAC clones of FIG. 2.

20. The method of claim 10, wherein the detecting is performed prior to administration of the anti-cancer therapy.

21. A BRCA1 classifier, comprising:
a plurality of probes, wherein the probes hybridize to DNA from at least one genomic locus selected from 1p34-21, 3p21, 3q22-27, 5q13-15, 5q21-23, 6p23-22, 10p14, 12q21-23, 13q31-33, and 14q22-24; and
wherein the probes detect a variation in copy number of the DNA from the at least one genomic locus.

22. The classifier of claim 21, wherein the probes hybridize to DNA from the genomic loci 1p34-21, 3q22-27, 6p23-22, 10p14 and 13q31-33.

23. The classifier of claim 21, wherein the probes hybridize to DNA from the genomic loci 3p21, 5q13-15, 5q21-23, 12q21-23 and 14q22-24.

24. The classifier of claim 21, wherein the probes hybridize to DNA from the genomic loci 1p34-21, 3p21, 3q22-27, 5q13-15, 5q21-23, 6p23-22, 10p14, 12q21-23, 13q31-33, and 14q22-24.

25-27. (canceled)
